(19) United States
(12) Patent Application Publication
(10) Pub. No.: US 2025/0286632 A1
(43) Pub. Date: Sep. 11, 2025

(54) Wireless Audio Data Transmission Method and Related Device

(71) Applicant: ZGMICRO HEFEI CO., LTD., Hefei (CN)

(72) Inventors: Bin XU, Hefei (CN); David Xiaodong YANG, Hefei (CN); Yingbin GAO, Hefei (CN)

(21) Appl. No.: 19/074,059

(22) Filed: Mar. 7, 2025

(30) Foreign Application Priority Data
Mar. 7, 2024 (CN) 2024102632391
Apr. 24, 2024 (CN) 2024105014466

(51) Int. Cl. H04B 11/00; H04L 12/18; H04L 65/70

(52) U.S. Cl. CPC H04B 11/00; H04L 12/189; H04L 65/70

(57) ABSTRACT

The present invention provides a wireless audio data transmission method and a related device. A master device performs broadcast communication with one or more first slave devices within continuous isochronous intervals to transmit an audio stream. The method comprises: obtaining a first audio data unit and a second audio data unit respectively based on an audio frame in the audio stream, wherein the first audio data unit and the second audio data unit obtained based on the same audio frame carry different audio information; encapsulating the first audio data unit to obtain a first broadcast data packet and encapsulating the second audio data unit to obtain a second broadcast data packet; and transmitting the first broadcast data packet via a first communication link group and the second broadcast data packet via a second communication link group within one of the isochronous intervals respectively, wherein an airtime slot occupied by the first audio data unit is greater than that occupied by the second audio data unit. The present invention enhances audio transmission reliability between the master device and the slave devices.

### CROSS-REFERENCE OF RELATED APPLICATIONS

The present invention claims priorities of Chinese Patent Application No. 2024102632391 filed in China on Mar. 7, 2024, and Chinese Patent Application No. 2024105014466 filed in China on Apr. 24, 2024, the entire contents of which are incorporated herein by reference.

### BACKGROUND OF THE INVENTION

### Field of the Invention

The present invention relates to the field of wireless audio technology, specifically to a wireless audio data transmission method and a related device.

### Description of the Related Art

Bluetooth Low Energy (BLE) audio technology utilizes an Isochronous Channels protocol, which includes a Connected Isochronous Stream (CIS) link for point-to-point communication and a Connected Isochronous Group (CIG) link protocol that comprises at least one CIS link. It also incorporates a Broadcast Isochronous Stream (BIS) link for point-to-multipoint communication and a Broadcast Isochronous Group (BIG) link protocol composed of at least one BIS link. This technology provides users with wireless audio services that offer lower power consumption, reduced cost, lower latency, enhanced quality, and broader functionality.

In practical applications, a Wireless Broadcast Audio (WBA) function for point-to-multipoint communication can be realized through the BIG link protocol. However, when using the BIG link for WBA, the available time slot resources are limited, restricting the number of packet retransmissions. This limitation results in unstable audio data transmission, particularly in environments with fading or interference. Consequently, audio playback may suffer from interruptions, leading to a poor user experience.

### SUMMARY OF THE INVENTION

The objective of the present invention is to provide a wireless audio data transmission method and a related device that improve the reliability of audio transmission in wireless broadcast audio (WBA) functions.

To achieve this objective, one aspect of the invention provides a wireless audio data transmission method applied to a master device. The master device is configured to perform broadcast communication with one or more first slave devices within continuous isochronous intervals to transmit an audio stream. The method includes obtaining a first audio data unit and a second audio data unit based on an audio frame in the audio stream, where the first and second audio data units derived from the same audio frame are defined as a target first audio data unit and a target second audio data unit, respectively. The audio information carried by the target second audio data unit is less than that carried by the target first audio data unit. The method further includes encapsulating the first audio data unit into a first broadcast data packet and encapsulating the second audio data unit into a second broadcast data packet. These packets are transmitted via different communication link groups within the same isochronous interval.

Another aspect of the invention provides a wireless audio data transmission method applied to a first slave device. The first slave device, which performs broadcast communication with a master device within continuous isochronous intervals, receives a first broadcast data packet from the master device based on the first communication link group and a second broadcast data packet based on the second communication link group within one of the isochronous intervals. The first and second audio data units are different data units obtained from the same audio frame, and the audio information carried by the target second audio data unit is less than that carried by the target first audio data unit.

Yet another aspect of the invention provides a wireless audio data transmission device applied to a master device. The master device is configured to perform broadcast communication with one or more first slave devices within continuous isochronous intervals to transmit an audio stream. The device comprises an obtaining module for acquiring a first and second audio data unit from an audio frame, an encapsulating module for creating first and second broadcast data packets, and a broadcast module for transmitting these packets through distinct communication link groups.

In this invention, the first and second audio data units correspond to the same audio frame but carry different levels of audio information. The second audio data unit, carrying less audio information, occupies fewer airtime slots. The first audio data unit is transmitted through the first communication link group, while the second audio data unit is transmitted through the second communication link group. If the first slave device fails to receive the first audio data unit correctly, it can still receive the second audio data unit via the second communication link group. This approach ensures stable audio transmission while minimizing the use of time slot resources, thereby improving the system's adaptability to challenging wireless environments.

The present invention and its various features, aspects, and advantages will be more fully understood with reference to the accompanying detailed description, claims, and drawings.

### BRIEF DESCRIPTION OF THE DRAWINGS

These and other features, aspects, and advantages of the present invention will become better understood with regard to the following description, appended claims, and accompanying drawings wherein:

FIG. 1 illustrates an exemplary schematic flowchart of a wireless audio data transmission method according to one embodiment of the present invention;

FIG. 2 illustrates an exemplary schematic diagram of a common extended advertising payload format according to one embodiment of the present invention;

FIG. 3 illustrates an exemplary schematic diagram of an extended packet header format according to one embodiment of the present invention;

FIG. 4 illustrates an exemplary schematic diagram of extended packet header flag bits according to one embodiment of the present invention;

FIG. 5 illustrates an exemplary schematic flowchart of another wireless audio data transmission method according to one embodiment of the present invention;

FIG. 6 illustrates an exemplary structural diagram of a wireless audio data transmission system according to one embodiment of the present invention;

FIG. 7 illustrates an exemplary schematic diagram of a time slot structure according to one embodiment of the present invention;

FIG. 8 illustrates an exemplary structural diagram of an HTWBA system with an A2DP audio source according to one embodiment of the present invention;

FIG. 9 illustrates an exemplary structural diagram of a wireless audio data transmission device according to one embodiment of the present invention;

FIG. 10 illustrates an exemplary structural diagram of another wireless audio data transmission device according to one embodiment of the present invention;

FIG. 11 illustrates an exemplary structural diagram of a wireless audio data transmission device according to one embodiment of the present invention;

FIG. 12 illustrates an exemplary structural diagram of an electronic device according to one embodiment of the present invention;

FIG. 13 illustrates an exemplary schematic diagram of a BIS timeslot configuration according to one embodiment of the present invention;

FIG. 14 illustrates an exemplary schematic diagram of an advertising session group according to one embodiment of the present invention;

FIG. 15 illustrates an exemplary schematic diagram of an auxiliary advertising packet carrying a compensation data packet according to one embodiment of the present invention;

FIG. 16 illustrates an exemplary schematic diagram of an auxiliary periodic advertising packet carrying a compensation data packet according to another embodiment of the present invention;

FIG. 17 illustrates an exemplary schematic diagram of an auxiliary advertising packet carrying compensation link information and a compensation data packet according to another embodiment of the present invention;

FIG. 18 illustrates an exemplary schematic diagram of a configuration scheme for data transmission timeslots according to one embodiment of the present invention;

FIG. 19 illustrates an exemplary schematic flowchart of encoding and transmitting an audio frame according to one embodiment of the present invention; and

FIG. 20 illustrates an exemplary schematic flowchart of a mixed encoding rate decoding scheme according to one embodiment of the present invention.

### DETAILED DESCRIPTION OF THE PREFERRED EMBODIMENTS

The detailed description of the invention is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be comprised in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

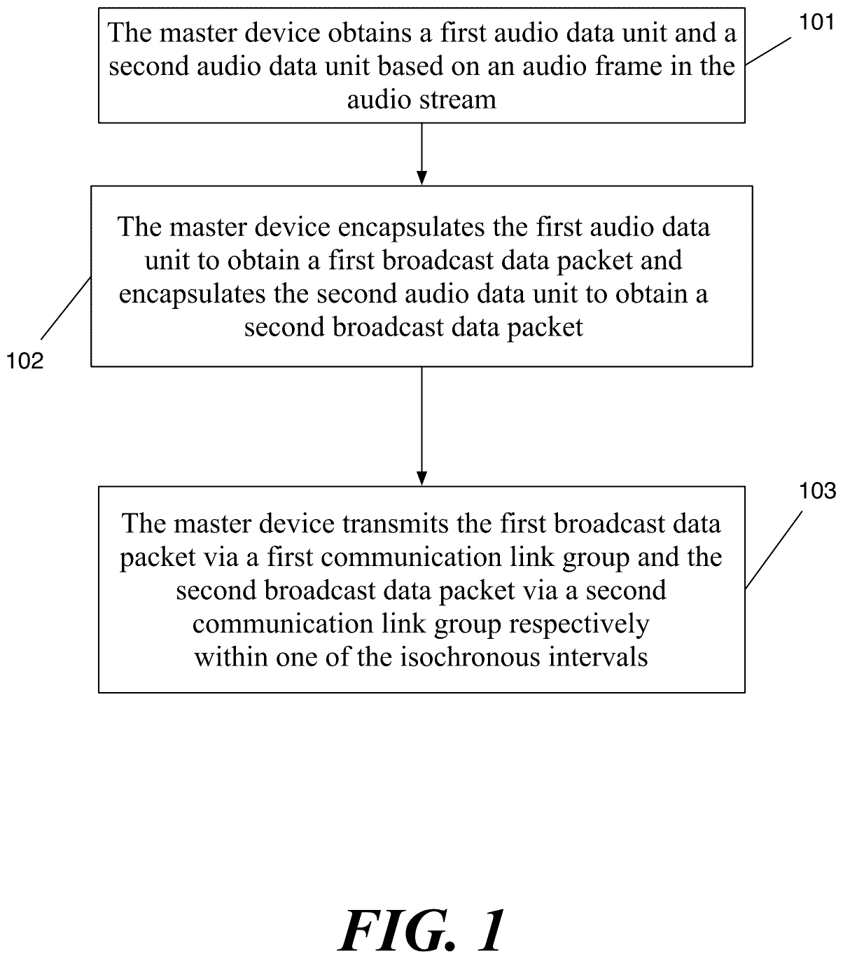

One embodiment of the present invention provides a wireless audio data transmission method for a master device. The master device communicates with N first slave devices within continuous isochronous intervals to transmit an audio stream, where N is an integer equal to or greater than 1. As illustrated in FIG. 1, this method comprises: the master device obtains a first audio data unit and a second audio data unit from an audio frame within the audio stream at 101.

The first and second audio data units, which are derived from the same audio frame, are referred to as the target first audio data unit and the target second audio data unit, respectively. The target second audio data unit contains a proper subset of the audio information carried by the target first audio data unit, meaning that the audio information in the second unit is reduced compared to the first.

The audio stream can include any form of digital audio, such as songs, movie soundtracks, recorded sounds (e.g., ambient noise or speech), or voice call data, or any form of digital audio as will be known to those or ordinary skill in the art.

The audio information contained within these data units represents various characteristics of the frequency spectrum of the audio signal. These characteristics include amplitude, phase, amplitude variation, and phase variation in both the time domain and the frequency domain.

Differences between the audio information carried by different audio data units comprise at least one of the following: a difference in the amplitude of corresponding frequency spectrum of the audio signal in the time domain; a difference in the phase of the corresponding frequency spectrum of the audio signal in the time domain; a difference in the amplitude variation of the corresponding frequency spectrum of the audio signal in the time domain; a difference in the phase variation of the corresponding frequency spectrum of the audio signal in the time domain; a difference in the amplitude of the corresponding frequency spectrum of the audio signal in the frequency domain; a difference in the phase of the corresponding frequency spectrum of the audio signal in the frequency domain; a difference in the amplitude variation of the corresponding frequency spectrum of the audio signal in the frequency domain; and a difference in the phase variation of the corresponding frequency spectrum of the audio signal in the frequency domain.

In one embodiment, the reduced audio information in the target second audio data unit comprises at least one of the following: a difference in the amplitude of corresponding frequency spectrum of the audio signal in the time domain; a difference in the phase of the corresponding frequency spectrum of the audio signal in the time domain; a difference in the amplitude variation of the corresponding frequency spectrum of the audio signal in the time domain; a difference in the phase variation of the corresponding frequency spectrum of the audio signal in the time domain; a difference in the amplitude of the corresponding frequency spectrum of the audio signal in the frequency domain; a difference in the phase of the corresponding frequency spectrum of the audio signal in the frequency domain; a difference in the amplitude variation of the corresponding frequency spectrum of the audio signal in the frequency domain; and a difference in the phase variation of the corresponding frequency spectrum of the audio signal in the frequency domain.

In one embodiment, the audio information carried by the target second audio data unit being less than audio information carried by the target first audio data unit comprises at least one of the following: a data amount of a data portion corresponding to a first indicator in the target second audio data unit is less than a data amount of a data portion corresponding to the first indicator in the target first audio data unit, and the first indicator is used for representing the amplitude of the corresponding frequency spectrum of the audio data unit in the time domain; a data amount of a data portion corresponding to a second indicator in the target second audio data unit is less than a data amount of a data portion corresponding to the second indicator in the target first audio data unit, and the second indicator is used for representing the phase of the corresponding frequency spectrum of the audio data unit in the time domain; a data amount of a data portion corresponding to a third indicator in the target second audio data unit is less than a data amount of a data portion corresponding to the third indicator in the target first audio data unit, and the third indicator is used for representing the amplitude variation of the corresponding frequency spectrum of the audio data unit in the time domain; a data amount of a data portion corresponding to a fourth indicator in the target second audio data unit is less than a data amount of a data portion corresponding to the fourth indicator in the target first audio data unit, and the fourth indicator is used for representing the phase variation of the corresponding frequency spectrum of the audio data unit in the time domain; a data amount of a data portion corresponding to a fifth indicator in the target second audio data unit is less than a data amount of a data portion corresponding to the fifth indicator in the target first audio data unit, and the fifth indicator is used for representing the amplitude of the corresponding frequency spectrum of the audio data unit in the frequency domain; a data amount of a data portion corresponding to a sixth indicator in the target second audio data unit is less than a data amount of a data portion corresponding to the sixth indicator in the target first audio data unit, and the sixth indicator is used for representing the phase of the corresponding frequency spectrum of the audio data unit in the frequency domain; a data amount of a data portion corresponding to a seventh indicator in the target second audio data unit is less than a data amount of a data portion corresponding to the seventh indicator in the target first audio data unit, and the seventh indicator is used for representing the amplitude variation of the corresponding frequency spectrum of the audio data unit in the frequency domain; a data amount of the data portion corresponding to an eighth indicator in the target second audio data unit is less than data amount of the data portion corresponding to the eighth indicator in the target first audio data unit, and the eighth indicator is used for representing the phase variation of the corresponding frequency spectrum of the audio data unit in the frequency domain.

For example, when the first audio data unit corresponds to lossless audio quality, the second audio data unit may correspond to standard audio quality and/or high-definition audio quality.

As illustrated in FIG. 1, the wireless audio data transmission method further comprises the following steps: the master device encapsulates the first audio data unit to create a first broadcast data packet and the second audio data unit to create a second broadcast data packet at step 102. The master device then transmits the first broadcast data packet via a first communication link group and the second broadcast data packet via a second communication link group within the same isochronous interval at step 103. The airtime slot allocated to the first audio data unit is greater than that allocated to the second audio data unit.

Both the first and second communication link groups can employ a pre-configured broadcast link protocol that supports isochronous audio data transmission. This protocol may be either public or private, and the first and second communication link groups can use the same or different protocols. To maximize system compatibility, the first communication link group is preferably configured with a public protocol for transmitting the first broadcast data packet. In one embodiment, the Broadcast Isochronous Group (BIG) link, composed of at least one Broadcast Isochronous Stream (BIS) link as defined by the Bluetooth Low Energy (BLE) specification, may serve as the first communication link group, while the second communication link group can be either a BIG link or a non-BIG link for audio data transmission.

The present invention leverages the transmission of two distinct audio data units derived from the same audio frame. The first audio data unit, carrying more information, is transmitted via the first communication link group, while the second audio data unit, carrying less information, is transmitted via the second communication link group. If the first slave device fails to receive the first audio data unit correctly, it can still retrieve the second audio data unit from the second communication link group, thereby enhancing the stability of audio transmission. This approach ensures efficient utilization of time slot resources and improves the reliability of audio streaming under limited slot conditions, ultimately enhancing the wireless broadcast audio (WBA) system's adaptability to various communication environments.

In one embodiment, at least M groups of second audio data units are transmitted via M groups of second communication link groups. A sequence of second broadcast data packets forms an auxiliary broadcast data packet stream, with M corresponding paths of such streams. Here, M represents a positive integer. Each path of the auxiliary broadcast data packet streams corresponds one-to-one with a second communication link group.

In an embodiment, one or more of the second audio data units are encapsulated within one second broadcast data packet. In an embodiment, the airtime slots occupied by the second audio data units of the second broadcast data packets transmitted on different second communication link groups are different. In an embodiment, the airtime slot occupied by any one of the first audio data units is greater than that occupied by any one of the second audio data units. It should be understood that there may also be multiple groups of the first audio data units. For example, when the first audio data unit corresponds to multi-channel audio, different groups of the first audio data units can respectively correspond to different channels of the multi-channel audio. In addition, when multiple second audio data units are encapsulated in one second broadcast data packet, the multiple second audio data units encapsulated in one second broadcast data packet can be the same second audio data unit or different second audio data units.

In one embodiment, within the same unit transmission duration, the number of transmissions of the second audio data unit is greater than the number of transmissions of the first audio data unit. In one embodiment, within the same unit transmission duration, the shorter the airtime slot occupied by the second audio data unit is, the more the number of transmissions of the second audio data unit is. The unit transmission duration is a duration for the first communication link group to retransmit the first broadcast data packet once.

With the above settings, the second audio data units that occupy shorter air time slots can be utilized to increase the number of transmissions of the audio data within the limited unit transmission duration. Therefore, when the time slot resources are limited, the total number of re-transmissions of the audio data can be increased. This can significantly improve the transmission reliability of the audio data and enhance the system's adaptability to the wireless communication environment.

In one embodiment, a high encoding rate is used to encode a target audio frame to obtain corresponding target first audio data unit, and a low encoding rate is used to encode the target audio frame to obtain corresponding target second audio data unit. The target audio frame is any one of the current audio frames within the audio stream.

It can be understood that the high encoding rate is greater than the low encoding rate. In this embodiment, by using different high and low encoding rates to encode the same audio frame, the target first audio data unit and the target second audio data unit carrying different audio information are obtained. The audio quality corresponding to the target first audio data unit is relatively high, and the audio quality corresponding to the target second audio data unit is relatively low. In one embodiment, the encoding rates of multiple second audio data units within one second broadcast data packet are the same. In one embodiment, the encoding rates of the second audio data units of the second broadcast data packets transmitted on different second communication link groups are different.

In other embodiments, the first audio data unit and the second audio data unit may be obtained based on one or more of a sampling rate, a quantization precision, an encoding rate, a frequency response, a dynamic range, and the like, which is not limited herein. In one embodiment, within one isochronous interval, the airtime slot occupied by the first audio data unit is adjacent to the airtime slot occupied by the second audio data unit. Through the above settings, allocation of time slot resources within the isochronous interval can be made more compact, which can improve a utilization rate of time slot resource and shorten a transmission latency of the audio data unit. When there are M groups of the second audio data units, within any one isochronous interval, the airtime slot occupied by the M groups of the second audio data units can also be set to be adjacent.

In one example, on the premise that the airtime slot occupied by the first audio data unit is adjacent to the airtime slot occupied by the second audio data unit within any one isochronous interval, it may be further set that the airtime slot occupied by the second audio data unit is located before the airtime slot occupied by the first audio data unit, so that the transmission of the second audio data unit does not affect the wireless communication on the first communication link group. In one embodiment, the airtime slot occupied by the first audio data unit is at least twice, such as twice or four times, etc., the airtime slot occupied by the second audio data unit.

It should be understood that when the first slave device can correctly receive the target first audio data unit carrying more audio information, the first slave device is preferable to obtain the relevant content of the corresponding audio frame through the target first audio data unit. In this case, the first slave device can choose to receive the target second audio data unit formed based on the same audio frame, or can choose not to receive it. The present invention does not limit this.

In a specific embodiment, the second audio data unit is used as candidate audio data for compensating the audio information carried by the first broadcast data packet when the first slave device fails to receive the first broadcast data packet.

In one embodiment, multiple consecutive first broadcast data packets form a primary broadcast data packet stream, multiple consecutive second broadcast data packets form an auxiliary broadcast data packet stream, and there are M paths of the auxiliary broadcast data packet stream.

In one embodiment, in order to facilitate synchronization between the slave device and the master device, the master device periodically transmits an auxiliary synchronization control data packet based on a periodic advertising channel. The auxiliary synchronization control data comprises a primary link information of the first communication link group and M auxiliary link information of the M groups of the second communication link groups. The auxiliary synchronization control data packet is used for the first slave device to synchronize with the master device, receive the primary broadcast data packet stream based on the first communication link group, and receive the M paths of the auxiliary broadcast data packet streams respectively based on the M groups of the second communication link groups. The periodic advertising channel can be one or more pre-specified channels. Before receiving the audio stream, the slave device first obtains the auxiliary synchronization control data packet based on the periodic advertising channel to complete the synchronization with the master device.

Further, the auxiliary synchronization control data packet comprises M enable parameters, the M enable parameters correspond one-to-one to the M groups of the second communication link groups, and the parameter value of each enable parameter is used to indicate whether the corresponding second communication link group is enabled.

By setting the enable parameters, the transmission control of the M paths of the auxiliary broadcast data packet streams can be made more flexible. In one embodiment, the first communication link group is a Broadcast Isochronous Group (BIG) link.

The auxiliary synchronization control data packet is a data packet in a common extended adverting payload format. An extended packet header of the auxiliary synchronization control data packet carries the BIG information of the Broadcast Isochronous Group link, and the M enable parameters occupy part or all of bits of a reserved field of the BIG information.

Exemplarily, the second communication link group may be the BIG link. In this example, the first communication link group can be understood as a primary link, and the second communication link group can be understood as an auxiliary link. An auxiliary synchronization (HT_AUX_SYNC_IND) Protocol Data Unit (PDU) can be defined with reference to the Bluetooth Low Energy (BLE) protocol. Here, the HT_AUX_SYNC_IND PDU can be understood as the aforementioned auxiliary synchronization control data packet.

The difference between the HT_AUX SYNC_IND PDU and the auxiliary synchronization (AUX_SYNC_IND) PDU defined by the BLE protocol is that, on the basis of the BIG link information (BIGInfo) carried by the AUX_SYNC_IND PDU, indication information of the auxiliary BIG link and the BIGInfo of the auxiliary BIG link are added. The BIGInfo carried by the AUX_SYNC_IND PDU can be understood as the primary link information of the first communication link group, and the indication information of the auxiliary BIG link and the BIGInfo of the auxiliary BIG link can be understood as the M auxiliary link information of the M groups of the second communication link groups.

According to the BLE protocol, the primary link information is used to provide the first slave device or the second slave device with information such as a starting point, an interval, an access address, and number of retransmissions of the BIS PDU transmitted by the master device on each BIG link, which will not be repeated here.

The above-mentioned second slave device can be understood as a slave device that can receive the first broadcast data packet transmitted by the master device based on the first communication link group but does not have ability to receive the second broadcast data packet. Therefore, in this example, any slave device supporting the BLE standard protocol (comprising the first slave device and the second slave device) can receive the audio stream based on the first communication link group, and the first slave device can also receive the audio stream based on the second communication link group, so that the system applies to a wider range.

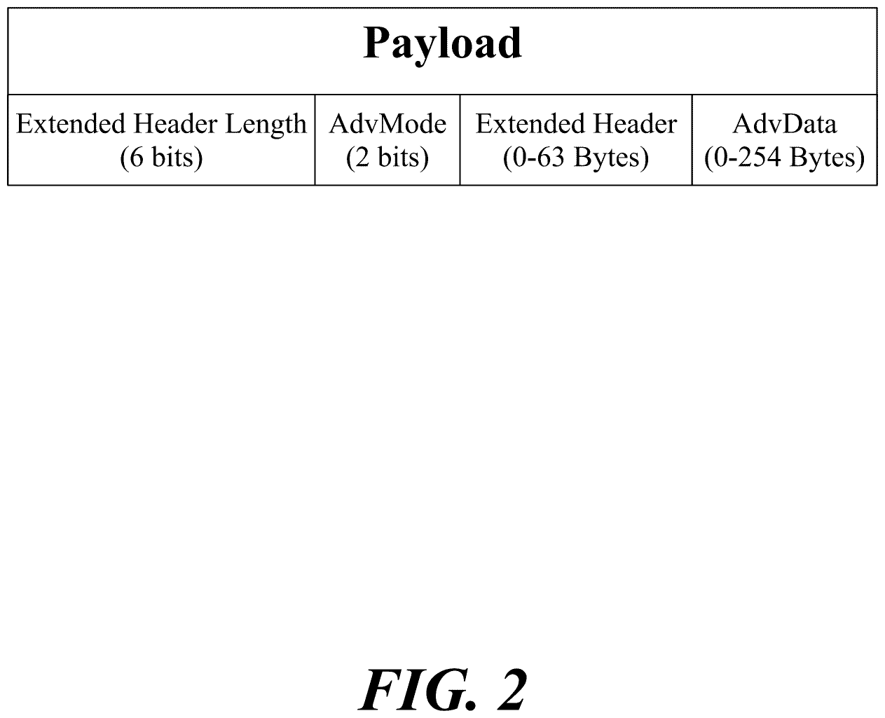

Similar to the AUX_SYNC_IND PDU defined by the BLE protocol, the HT AUX_SYNC_IND PDU adopts a Common Extended Advertising Payload Format shown in FIG. 2 in the BLE specification, which comprises a 6-bit Extended Header Length, a 2-bit advertising mode (AdvMode), an extended header (Extended Header) of 0-63 bytes, and an advertising data (AdvData) of up to 254 bytes.

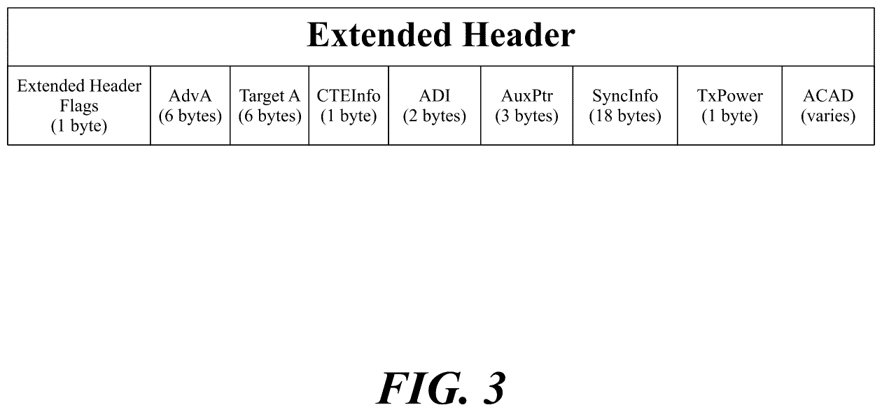

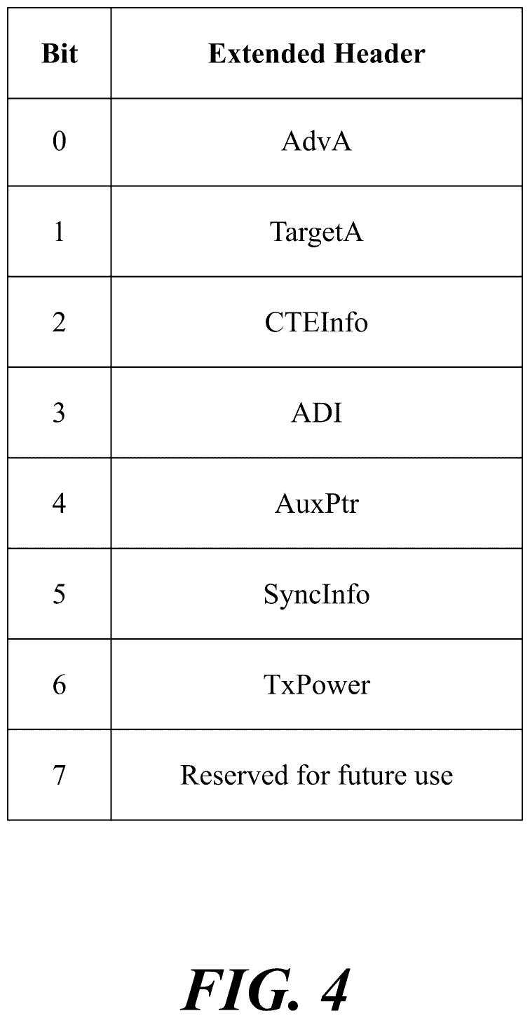

As shown in FIG. 3, the extended header may comprise fields such as Extended Header Flags, AdvA, TargetA, CTEInfo, ADI, AuxPtr, SyncInfo, TxPower, and ACAD. Extended Header Flags are extended header flag bits. As shown in FIG. 4, each bit corresponds to an extended header field. Setting a certain bit of the extended header flag bits to 1 indicates that the corresponding field exists in the extended header, and setting a certain bit of the extended header flag bits to 0 indicates that the corresponding field does not exist in the extended header. AdvA represents a device address of an advertising transmitting device, TargetA represents a device address of a target device, CTEInfo represents Constant Tone Extension (CTE) information, ADI represents advertising data information, AuxPtr represents an auxiliary advertising pointer, SyncInfo represents synchronization information, TxPower represents a transmission power, and ACAD represents Additional Controller Advertising Data.

The AUX_SYNC_IND PDU carries the BIG information (BIGInfo) through the ACAD, wherein there is an 8-bit reserved field (Reserved for Future Use, RFU) in the BIGInfo. The HT_AUX_SYNC_IND PDU defines part or all of bits in the reserved field of the BIGInfo as auxiliary BIG link enable bits, which are used to indicate whether to enable the auxiliary BIG link and how many groups of the auxiliary BIG links are enabled. The BIGInfo is the aforementioned BIG information, and the auxiliary BIG link enable bits are the bits occupied by the M enable parameters in the reserved field of the BIG information.

The auxiliary BIG link enables bits from low to high are HT_EN_1, HT_EN_2, . . . , HT_EN_M. Setting a certain auxiliary BIG link enable bit to 1 indicates that the auxiliary BIG-link of its corresponding sequence is enabled, that is, the corresponding second communication link group is enabled, and set to 0 indicates that the corresponding auxiliary BIG-link is not enabled.

When a certain auxiliary BIG link enable bit is set to 1, the BIGInfo of the corresponding auxiliary BIG link is carried in the AdvData of the HT_AUX_SYNC_IND PDU. The definition of the BIGInfo of the auxiliary BIG link is the same as that of the BIG link defined by the BLE protocol. The BIGInfo of the auxiliary BIG link in the AdvData is arranged in sequence according to a serial number. BIGInfo 1 corresponds to the auxiliary BIG link with the serial number 1, and BIGInfo M corresponds to the auxiliary BIG link with the serial number M.

In this example, the first slave device first searches for the extended adverting (ADV_EXT_IND) PDU transmitted by the master device on a primary advertising channel, then receives an auxiliary adverting (AUX_ADV_IND) PDU transmitted by the master device on a secondary advertising channel, and then receives the HT_AUX_SYNC_IND PDU transmitted by the master device on the periodic advertising channel to synchronize with the master device. It also obtains the link information (BIGInfo) of the primary BIG, the enable information of the auxiliary BIG link, and the link information (BIGInfo) of the auxiliary BIG link, so as to receive the audio data carried by the BIS PDU of the primary BIG link and the audio data carried by the BIS PDU of the auxiliary BIG link. The BIS PDU of the primary BIG link can be understood as the aforementioned first broadcast data packet, and the audio data carried by the BIS PDU of the primary BIG link can be understood as the aforementioned first audio data unit. The BIS PDU of the auxiliary BIG link can be understood as the aforementioned second broadcast data packet, and the audio data carried by the BIS PDU of the auxiliary BIG link can be understood as the aforementioned second audio data unit.

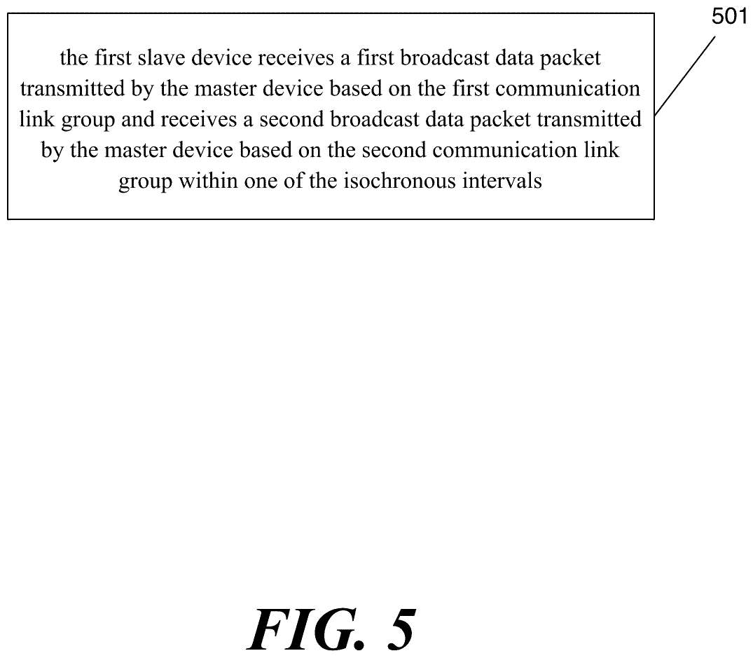

A wireless audio data transmission method applied to a first slave device is provided according to one embodiment of the present invention. The first slave device performs broadcast communication with the master device within continuous isochronous intervals to transmit an audio stream. As shown in FIG. 5, the wireless audio data transmission method comprises: the first slave device receives a first broadcast data packet transmitted by the master device based on a first communication link group and receives a second broadcast data packet transmitted by the master device based on a second communication link group within one of the isochronous intervals at 501.

The first broadcast data packet is a broadcast data packet obtained by encapsulating the first audio data unit by the master device, and the second broadcast data packet is a broadcast data packet obtained by encapsulating the first audio data unit by the master device.

The first audio data unit and the second audio data unit are different data units obtained by the master device based on an audio frame in the audio stream. An airtime slot occupied by the first audio data unit is greater than an airtime slot occupied by the second audio data unit.

The first audio data unit and the second audio data unit obtained by the master device based on the same audio frame are defines as a target first audio data unit and a target second audio data unit respectively. Audio information carried by the target second audio data unit is a proper subset of audio information carried by the target first audio data unit. In other words, the audio information carried by the target second audio data unit is less than the audio information carried by the target first audio data unit.

In one embodiment, there are at least M groups of the second audio data units, and there are M groups of the second communication link groups, and a plurality of consecutive second broadcast data packets form an auxiliary broadcast data packet stream, there are M paths of the auxiliary broadcast data packet streams, and M is a positive integer.

The M paths of the auxiliary broadcast data packet streams respectively correspond one-to-one to the M groups of the second communication link groups.

One or more of the second audio data units are encapsulated within one second broadcast data packet. In one embodiment, the airtime slot occupied by the second audio data units of the second broadcast data packets transmitted on different second communication link groups are different.

In one embodiment, the airtime slot occupied by any one of the first audio data units is greater than that occupied by any one of the second audio data units. In one embodiment, before 501, the method further comprises: receiving an auxiliary synchronization control data packet transmitted by the master device based on a periodic advertising channel; and synchronizing with the master device based on the auxiliary synchronization control data packet. The auxiliary synchronization control data comprises a primary link information of the first communication link group and M auxiliary link information of the M groups of the second communication link groups.

In one embodiment, the auxiliary synchronization control data packet comprises M enable parameters, the M enable parameters correspond one-to-one to the M groups of the second communication link groups, and a parameter value of each enable parameter is used to indicate whether the corresponding second communication link group is enabled.

The first slave device receives the second broadcast data packet transmitted by the master device based on the enabled second communication link group when the first communication link group is in an abnormal state. The abnormal state is used to indicate that communication quality of the first communication link group is lower than a quality threshold, and/or a variation amplitude of the communication quality of the first communication link group is higher than an amplitude threshold.

In this embodiment, the first slave device will select whether to use the enabled second communication link group to receive the second broadcast data packet according to channel quality of the first communication link group. Specifically, when the first communication link group is not in the abnormal state, the first slave device does not receive the second broadcast data packet transmitted by the master device.

When there is no enabled second communication link group between the first slave device and the master device, the first slave device does not receive the second broadcast data packet transmitted by the master device. When the first communication link group is not in the abnormal state and there is no enabled second communication link group between the first slave device and the master device, the first slave device does not receive the second broadcast data packet transmitted by the master device.

Through the above settings, when the first broadcast data packet can be normally received by the first slave device, the first slave device is made not to receive the second broadcast data packet transmitted by the master device, which can reduce the resource overhead of the first slave device caused by waiting to receive the second broadcast data packet.

The first slave device will periodically monitor the communication quality of the first communication link group to decide whether to receive the second broadcast data packet. A duration of one monitoring cycle is called a unit monitoring duration. A specific value of the unit monitoring duration can be adaptively determined according to actual needs, which is not limited in the present invention.

Exemplarily, when the first slave device monitors that the communication quality of the first communication link group is lower than a quality threshold and/or a variation amplitude of the communication quality of the first communication link group is higher than the amplitude threshold within a certain monitoring cycle, the first slave device can receive the second broadcast data packet in the next monitoring cycle.

Exemplarily, the first slave device can determine the communication quality of the first communication link group within a certain monitoring cycle according to one or more indicators such as a correct rate/error packet rate/packet loss rate of receiving the first broadcast data packet within this monitoring cycle. The higher the correct rate is, the higher the communication quality of the first communication link group within this monitoring cycle is indicated. The higher the error packet rate is, the lower the communication quality of the first communication link group within this monitoring cycle is indicated. The higher the packet loss rate is, the lower the communication quality of the first communication link group within this monitoring cycle is indicated.

Further, the first slave device can compare the communication quality of the first communication link group within a certain monitoring cycle with the communication quality of the first communication link group within the previous monitoring cycle of this monitoring cycle to determine the variation amplitude of the communication quality of the first communication link group within this monitoring cycle. The variation amplitude of the communication quality of the first communication link group within the first monitoring cycle is 0.

In one embodiment, within any one of the isochronous intervals, the first slave device receives the first broadcast data packet transmitted by the master device based on the first communication link group, and receives the second broadcast data packet transmitted by the master device based on the second communication link group.

In one embodiment, the method further comprises: when at least two candidate audio data units corresponding to the same audio frame are successfully received, selecting one candidate audio data unit carrying the most audio information from the at least two candidate audio data units corresponding to the same audio frame as the target candidate audio data unit.

The target candidate audio data unit is the first audio data unit or the second audio data unit. When multiple candidate audio data units corresponding to the same audio frame are received, the candidate audio data unit carrying the most audio information is selected as the target candidate audio data unit, so that the audio quality of the corresponding audio frame can be improved when the corresponding audio frame is output externally.

It should be understood that the determined target candidate audio data unit can be used for purposes such as audio playback, audio analysis, and audio testing, and the present invention does not limit this. For example, the at least two candidate audio data units may be the first audio data unit and at least one second audio data unit. The at least two candidate audio data units may also be at least two second audio data units.

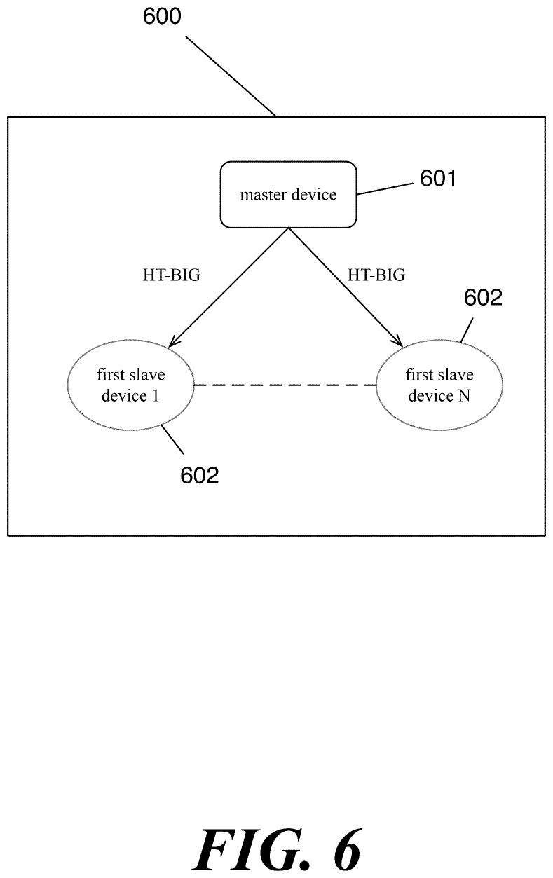

A wireless audio data transmission system is provided according to one embodiment of the present invention. As shown in FIG. 6, the wireless audio data transmission system 600 comprises: a master device 601 and N first slave devices 602. N is an integer greater than or equal to 1.

The master device 601 performs broadcast communication with the N first slave devices 602 within continuous isochronous intervals to transmit an audio stream.

The master device 601 is configured to respectively obtain a first audio data unit and a second audio data unit based on an audio frame in the audio stream. The first audio data unit and the second audio data unit obtained based on the same audio frame are defined as a target first audio data unit and a target second audio data unit, respectively. The audio information carried by the target second audio data unit is a proper subset of the audio information carried by the target first audio data unit. In other words, the audio information carried by the target second audio data unit is less than that carried by the target first audio data unit.

The master device 601 is configured to encapsulate the first audio data unit to obtain a first broadcast data packet, and encapsulate the second audio data unit to obtain a second broadcast data packet.

The master device 601 is configured to transmit the first broadcast data packet via a first communication link group and the second broadcast data packet via a second communication link group within one of the isochronous intervals respectively, wherein an airtime slot occupied by the first audio data unit is greater than that occupied by the second audio data unit.

At least one first slave devices 602 receives the first broadcast data packet transmitted by the master device based on the first communication link group and receives the second broadcast data packet transmitted by the master device based on the second communication link group within one of the isochronous intervals.

In one embodiment, the system 600 further comprises at least one second slave device. The second slave device does not support wireless communication with the master device 601 based on the second communication link group. Within any one of the isochronous intervals, the second slave device receives the first broadcast data packet transmitted by the master device 601 based on the first communication link group.

The second slave device can be understood as a common WBA slave device or a common BIG slave device. By introducing the second slave device into the system 600, the system 600 can be compatible with the common WBA slave device or the common BIG slave device that communicates only based on the BLE Audio technology standard protocol.

In one embodiment, the first communication link group is a Broadcast Isochronous Group (BIG) link; the second communication link group is a BIG link or a non-BIG link for transmitting audio data. Exemplarily, the non-BIG link for transmitting audio data may comprise one or more of an auxiliary advertising link, a periodic advertising link, a custom broadcast link, and a hidden broadcast link.

In some specific embodiments, the method of the present invention may also be referred to as a Hierarchical Transmission Scheme of WBA. The wireless audio transmission system using the method of the present invention can be referred to as a Hierarchical Transmission based Wireless Broadcast Audio (HTWBA) system. The master device in the present invention is an HTWBA master device, the first slave device in the present invention is an HTWBA slave device, the first communication link group is the primary BIG link, the second communication link group is the auxiliary BIG link, and the corresponding link of the HTWBA system is the HT-BIG link. The HT-BIG link comprises the primary BIG link and at least one auxiliary BIG link.

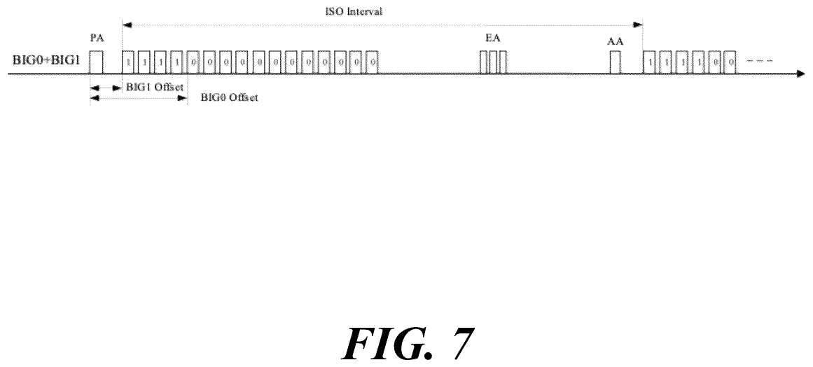

FIG. 7 shows a corresponding time slot structure by taking one primary BIG link and one auxiliary BIG link as an example. In FIG. 7, the box with 1 represents the BIS PDU of the auxiliary BIG link, and the box with 0 represents the BIS PDU of the primary BIG link. The primary BIG link and the auxiliary BIG link share the same extended adverting (represented by EA in FIG. 7), auxiliary adverting (represented by AA in FIG. 7), and hierarchical transmission auxiliary synchronization adverting (represented by PA in FIG. 7).

The BIG offset value Offset0 (corresponding to the primary BIG link) carried in the BIGInfo is greater than the BIG offset value Offset1 (corresponding to the auxiliary BIG link), which means that the BIS PDU of the auxiliary BIG link is sent first, and then the BIS PDU of the primary BIG link is sent, so as to avoid time slot conflicts, eliminate influence on the primary BIG link, reduce design difficulty, and ensure the compatibility of the system.

Based on the time slot structure shown in FIG. 7, taking the hierarchical

transmission with high encoding rate and low encoding rate as an example, the transmission process on an HTWBA master device side is as follows.

A Host protocol layer of the HTWBA master device compresses and encodes the audio data into high encoding rate audio data (which can be understood as the aforementioned first audio data unit) and low encoding rate audio data (which can be understood as the aforementioned second audio data unit), respectively encapsulates them into corresponding Service Data Units (SDUs), and then transmits them to a Controller of the HTWBA master device through a Host Controller Interface (HCl). After receiving the SDUs with different encoding rates, the Controller encapsulates them into the BIS PDUs of each BIG link, and then transmits the BIS PDUs in sequence according to parameters provided by the BIGInfo of each BIG link. The Host protocol layer, the Host control interface, and the controller on the HTWBA master device side all correspond to a baseband data and protocol processor in the HTWBA master device, which is used to execute relevant protocols of the HT-BIG link and process the audio data into the BIS PDUs suitable for radio frequency transmission and reception.

The receiving process of the time slot structure shown in FIG. 7 on a HTWBA slave device side is as follows. For the HTWBA slave device, it needs to first search for the ADV_EXT_IND PDU, then receive the AUX_ADV_IND PDU, and receive the HT_AUX_SYNC_IND PDU according to the synchronization information of the AUX_ADV_IND PDU. Then, it receives the corresponding BIS PDUs in sequence according to the BIGInfo of each BIG link provided by the HT_AUX_SYNC_IND PDU.

If the channel quality of the wireless environment is good, a Controller of the HTWBA slave device only receives the BIS PDU of the primary BIG link, and the Controller of the HTWBA slave device submits the Service Data Unit of the primary encoding rate audio data carried by the BIS PDU of the primary BIG link to a Host layer through a Host control interface. If the channel quality of the wireless environment is poor, the Controller of the HTWBA slave device not only receives the BIS PDU of the primary BIG link but also receives the BIS PDU of the auxiliary BIG link.

In this case, if the Controller of the HTWBA slave device correctly receives the BIS PDU of the primary BIG link, it submits the Service Data Unit of the primary encoding rate audio data carried by the BIS PDU of the primary BIG link to the Host layer through the Host Controller Interface (HCl). If the Controller does not correctly receive the BIS PDU of the primary BIG link but receives the BIS PDU of the auxiliary BIG link correctly, it submits the Service Data Unit (SDU) of the auxiliary encoding rate audio data carried by the BIS PDU of the auxiliary BIG link to the Host layer through the HCl. If the Controller does not correctly receive the BIS PDUs of both the primary BIG link and the auxiliary BIG link, it submits packet loss information to the Host layer through the HCl, so that an audio processing unit can perform a Packet Loss Concealment (PLC) according to the packet loss information. The primary protocol layer, the primary control interface, and the controller on the HTWBA slave device side all correspond to a baseband data and protocol processor in the HTWBA slave device, which is used to execute the relevant protocols of the HT-BIG link and process the received BIS PDUs transmitted by the HTWBA master device.

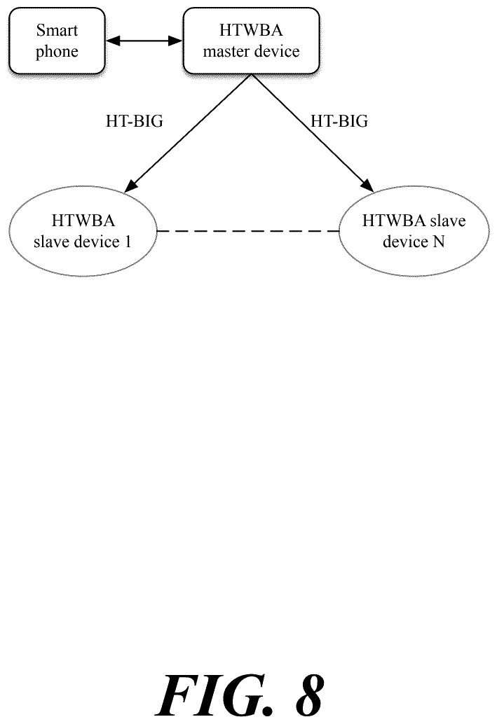

For ease of understanding, the HTWBA system with an Advanced Audio Distribution Profile (A2DP) audio source is taken as an example, and description is as follows. As shown in FIG. 8, the HTWBA master device is connected to a smartphone. The HTWBA master device uses a Classic Bluetooth module (Classic BT) A2DP to obtain the audio stream from the smartphone, and then transmits it to the HTWBA slave device through the HT-BIG link. The transmitting time slots of the HT-BIG link of the HTWBA master device co-exist in a time division manner with the transmitting and receiving time slots of a Classic BT link.

The HT-BIG link in this example is composed of two different BIG links, comprising a primary BIG link and an auxiliary BIG link. For the convenience of description, BIG0 is used to refer to the primary BIG link, and BIG1 is used to refer to the auxiliary BIG link. BIG0 uses the primary encoding rate, and BIG1 uses the auxiliary encoding rate. The primary encoding rate is higher than the auxiliary encoding rate. The high encoding rate corresponds to high quality audio performance, and the low encoding rate corresponds to basic quality audio performance.

In a specific embodiment, after receiving the A2DP audio stream, the HTWBA master device first decodes it, then resamples and re-encodes it according to requirements of the HT-BIG link, and respectively encodes it into one channel of primary encoding rate and one channel of auxiliary encoding rate. The main parameters of BIG0 comprise: a frame length encoded by a Low Complexity Codec (LC3) with a sampling rate of 48 KHz is 10 ms, a mono-channel encoding rate is 80 kbps, a size of a mono-channel service data unit is 100 bytes, the Isochronous Interval (ISO Interval) of BIG0 is 20 ms, the number of BIS links is 2, the Number of Sub-Event (NSE) is equal to 6, a Burst Number (BN) is equal to 2, an Immediate Repetition Count (IRC) is equal to 3, and a value of the Pre-Transmission Offset (PTO) is equal to 0.

A payload size of the BIS PDU is 100 bytes, containing one SDU of one channel. The interval or the airtime slot occupied by each BIS PDU is 624 us. It uses a BLE 2 Mbps physical layer for transmission. The interval of the periodic adverting is 60 ms, and an offset value (BIG0 Offset) between a starting point of the periodic adverting and a starting point of BIG0 is 3.75 ms.

The main parameters of BIG1 comprise: the frame length encoded by LC3 with a sampling rate of 48 KHz is 10 ms, the mono-channel encoding rate is 20 kbps, a size of a mono-channel service data unit is 25 bytes, the Isochronous Interval (ISO Interval) of BIG1 is 20 ms, the number of BIS links is 1, the Number of Sub-Event (NSE) is equal to 4, the Burst Number (BN) is equal to 1, the Immediate Repetition Count (IRC) is equal to 4, and the value of the Pre-Transmission Offset (PTO) is equal to 0.

The payload size of the BIS PDU is 100 bytes, containing two SDUs for each of the two channels, that is, a total of four 25-byte SDUs. The interval or the airtime slot occupied by each BIS PDU is 624 us. It uses the BLE 2 Mbps physical layer for transmission. The interval of the periodic adverting is 60 ms, and the interval (BIG1 Offset) between the starting point of the periodic adverting and the starting point of BIG1 is 1.23 ms.

Through the above settings, within the time slot for one retransmission of BIG0 (the air time for transmitting 4 BIS PDUs), BIG1 can retransmit the SDUs using the auxiliary encoding rate 4 times. In this way, the transmission reliability of the audio data with the auxiliary encoding rate is greatly improved, thereby ensuring the basic quality of the wireless audio broadcast. In practical applications, the auxiliary encoding rate used by BIG1 is used to retain the highest energy audio spectrum or the low frequency audio spectrum to provide basic audio quality. The spectrum part compressed during the encoding process can be compensated when a receiving device performs packet loss compensation.

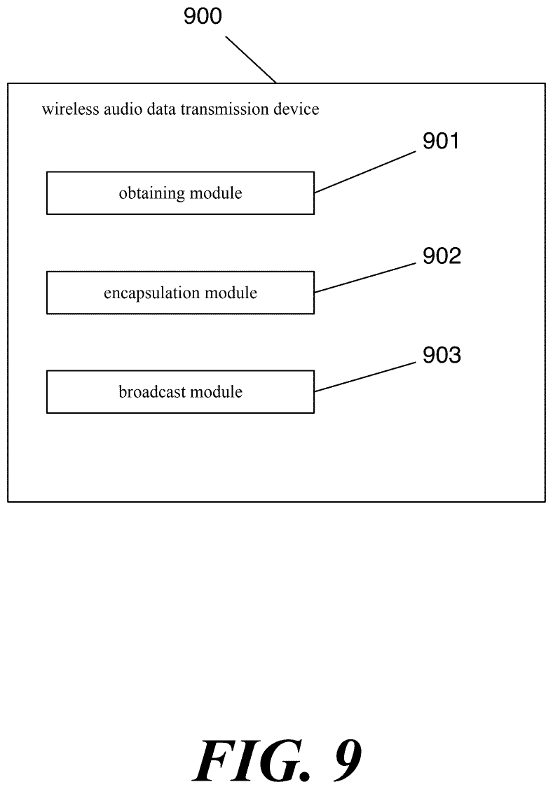

A wireless audio data transmission device applied to a master device is provided according to one embodiment of the present invention. The master device performs broadcast communication with N first slave devices within continuous isochronous intervals to transmit an audio stream. As shown in FIG. 9, the wireless audio data transmission device 900 comprises an obtaining module 901, an encapsulation module 902 and a broadcast module 903.

The obtaining module 901 is configured to respectively obtain a first audio data unit and a second audio data unit based on an audio frame in the audio stream. The first audio data unit and the second audio data unit acquired based on the same audio frame are respectively a target first audio data unit and a target second audio data unit. The audio information carried by the target second audio data unit is a proper subset of the audio information carried by the target first audio data unit. In other words, the audio information carried by the target second audio data unit is less than that carried by the target first audio data unit.

The encapsulation module 902 is configured to encapsulate the first audio data unit to obtain a first broadcast data packet, and encapsulate the second audio data unit to obtain a second broadcast data packet.

The broadcast module 903 is configured to transmit the first broadcast data packet via a first communication link group and the second broadcast data packet via a second communication link group within one of the isochronous intervals respectively. The airtime slot occupied by the first audio data unit is greater than the airtime slot occupied by the second audio data unit.

In one embodiment, there are at least M groups of the second audio data units, and there are M groups of the second communication link groups. Multiple consecutive second broadcast data packets form an auxiliary broadcast data packet stream, and there are M paths of the auxiliary broadcast data packet streams, wherein M is a positive integer.

The M paths of the auxiliary broadcast data packet streams respectively correspond one-to-one to the M groups of the second communication link groups.

One or more of the second audio data units are encapsulated within one second broadcast data packet.

The airtime slots occupied by the second audio data units of the second broadcast data packets transmitted on different second communication link groups are different.

The airtime slot occupied by any one of the first audio data units is greater than that occupied by any one of the second audio data units.

In one embodiment, within the same unit transmission duration, the number of transmissions of the second audio data unit is greater than the number of transmissions of the first audio data unit.

Within the same unit transmission duration, the shorter the airtime slot occupied by the second audio data unit is, the more the number of transmissions of the second audio data unit is.

The unit transmission duration is the duration for the first communication link group to retransmit the first broadcast data packet once.

In one embodiment, the obtaining module 901 is specifically configured to: use a high encoding rate to encode a target audio frame to obtain corresponding target first audio data unit, and use a low encoding rate to encode the target audio frame to obtain corresponding target second audio data unit. The target audio frame is any current audio frame in the audio stream.

The encoding rates of multiple second audio data units in one second broadcast data packet are the same. The encoding rates of the second audio data units of the second broadcast data packets transmitted on different second communication link groups are different.

In one embodiment, within one isochronous interval, the airtime slot occupied by the first audio data unit is adjacent to the airtime slot occupied by the second audio data unit. In one embodiment, the airtime slot occupied by the first audio data unit is at least twice that occupied by the second audio data unit.

The second audio data unit is used as candidate audio data to compensate for the audio information carried by the first broadcast data packet when the first slave device fails to receive the first broadcast data packet. In one embodiment, multiple consecutive first broadcast data packets form a primary broadcast data packet stream.

The device 900 further comprises: a control packet transmission module configured to transmit an auxiliary synchronization control data packet based on a periodic advertising channel. The auxiliary synchronization control data comprises a primary link information of the first communication link group and M auxiliary link information of the M groups of the second communication link groups, and the auxiliary synchronization control data packet is used for the first slave device to synchronize with the master device, receive the primary broadcast data packet stream based on the first communication link group, and receive the M paths of the auxiliary broadcast data packet streams respectively based on the M groups of the second communication link groups.

In one embodiment, the auxiliary synchronization control data packet comprises M enable parameters. The M enable parameters correspond one-to-one to the M groups of the second communication link groups, and a parameter value of each enable parameter is used to indicate whether the corresponding second communication link group is enabled.

In one embodiment, the first communication link group is a Broadcast Isochronous Group (BIG) link, and the second communication link group is a BIG link or a non-BIG link for transmitting audio data.

The auxiliary synchronization control data packet is a data packet in a common extended advertising payload format, an extended header of the auxiliary synchronization control data packet carries Broadcast Isochronous Group (BIG) information, and the M enable parameters occupy part or all of bits of a reserved field of the BIG information.

The wireless audio data transmission device 900 provided in the embodiment of the present invention can implement each process in the embodiment of the wireless audio data transmission method on the master device side. To avoid repetition, details are not described here again.

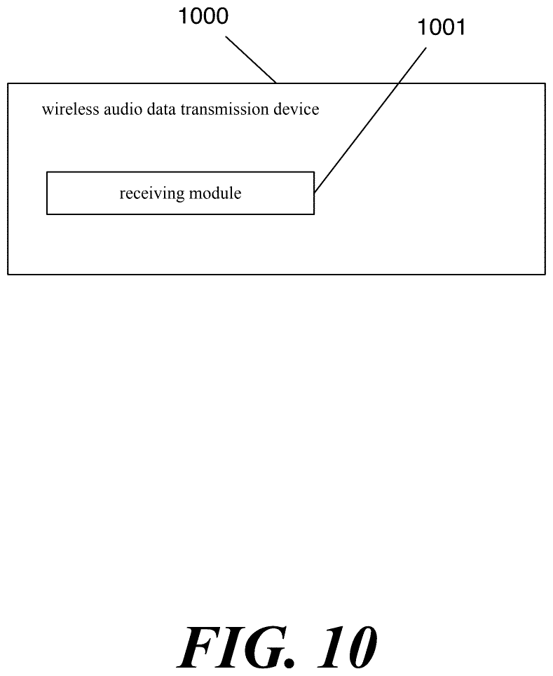

A wireless audio data transmission device applied to a first slave device is provided according to one embodiment of the present invention. The first slave device performs broadcast communication with a master device within continuous isochronous intervals to transmit an audio stream. As shown in FIG. 10, the wireless audio data transmission device 1000 comprises: a receiving module 1001 configured to receive a first broadcast data packet transmitted by the master device based on a first communication link group and receive a second broadcast data packet transmitted by the master device based on a second communication link group within one of the isochronous intervals.

The first broadcast data packet is a broadcast data packet obtained by encapsulating the first audio data unit by the master device, and the second broadcast data packet is a broadcast data packet obtained by encapsulating the first audio data unit by the master device.

The first audio data unit and the second audio data unit are different data units obtained by the master device based on an audio frame in the audio stream. The airtime slot occupied by the first audio data unit is greater than the airtime slot occupied by the second audio data unit.

The first audio data unit and the second audio data unit obtained by the master device based on the same audio frame are defines as a target first audio data unit and a target second audio data unit respectively. The audio information carried by the target second audio data unit is a proper subset of the audio information carried by the target first audio data unit. In other words, the audio information carried by the target second audio data unit is less than the audio information carried by the target first audio data unit.

In one embodiment, there are at least M groups of the second audio data units, and there are M groups of the second communication link groups, and a plurality of consecutive second broadcast data packets form an auxiliary broadcast data packet stream, there are M paths of the auxiliary broadcast data packet stream, wherein M is a positive integer.

The M paths of auxiliary broadcast data packet streams respectively correspond one-to-one to the M groups of the second communication link groups. One or more of the second audio data units are encapsulated in one second broadcast data packet. The airtime slot occupied by the second audio data units of the second broadcast data packets transmitted on different second communication link groups are different.

The airtime slot occupied by any one of the first audio data units is greater than the airtime slot occupied by any one of the second audio data units. In one embodiment, the device 1000 further comprises: a control data packet receiving module, configured to receive an auxiliary synchronization control data packet transmitted by the master device based on a periodic advertising channel. The auxiliary synchronization control data comprises a primary link information of the first communication link group and M auxiliary link information of the M groups of the second communication link groups.

In one embodiment, the device 1000 further comprises: a synchronization module, configured to synchronize with the master device based on the auxiliary synchronization control data packet. In one embodiment, the auxiliary synchronization control data packet comprises M enable parameters. The M enable parameters correspond one-to-one to the M groups of the second communication link groups, and a parameter value of each enable parameter is used to indicate whether the corresponding second communication link group is enabled.

The receiving module 1001 is specifically configured to: receive the second broadcast data packet transmitted by the master device based on the enabled second communication link group when the first communication link group is in an abnormal state. The abnormal state is used to indicate that communication quality of the first communication link group is lower than a quality threshold, and/or a variation amplitude of the communication quality of the first communication link group is higher than an amplitude threshold.

In one embodiment, the receiving module 1001 is specifically configured to: receive the first broadcast data packet transmitted by the master device based on the first communication link group and receive the second broadcast data packet transmitted by the master device based on the second communication link group respectively within any one of the isochronous intervals.

In one embodiment, the device 1000 further comprises: a reporting module configured to, when at least two candidate audio data units corresponding to the same audio frame are successfully received, select one candidate audio data unit carrying the most audio information from the at least two candidate audio data units corresponding to the same audio frame as the target candidate audio data unit.

The target candidate audio data unit is the first audio data unit or the second audio data unit. The wireless audio data transmission device 1000 provided in the embodiment of the present invention can implement each process in the embodiment of the wireless audio data transmission method on the first slave device side. To avoid repetition, details are not described here again.

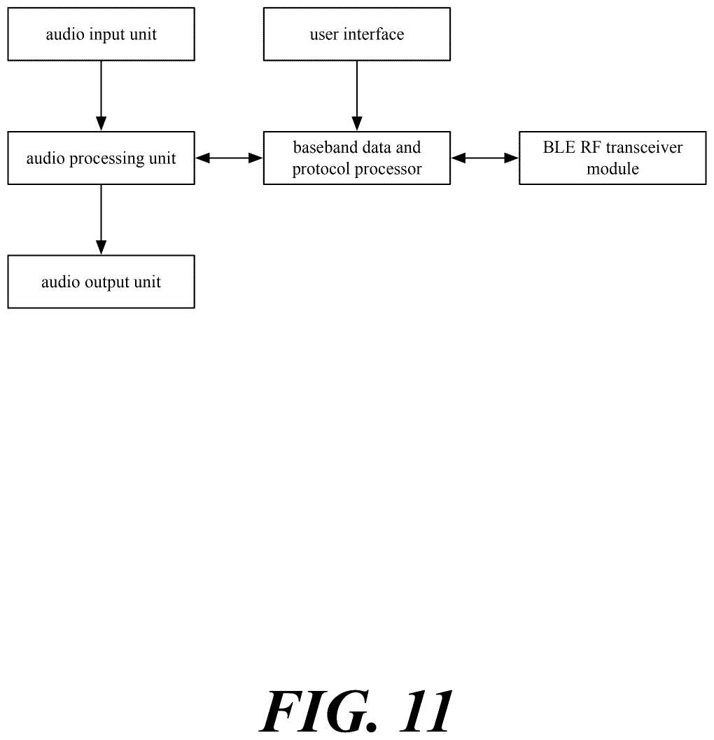

Referring to FIG. 11, when a structure shown in FIG. 11 is the HTWBA master device, it may comprise a user interface, an audio input unit, an audio output unit, an audio processing unit, a baseband data and protocol processor, and a Bluetooth (BT) radio frequency (RF) transceiver module.

The audio input unit is used to acquire a digital audio signal and transmit it to the audio processing unit. In the aforementioned example, the audio input unit is a module for wirelessly receiving an A2DP audio source.

The audio processing unit first performs SBC decoding and then compresses and encodes it into audio data using LC3. The baseband data and protocol processor execute relevant protocols of the HT-BIG link and processes the audio data into BIS PDUs suitable for transmission by the BT radio frequency transceiver module.

The BT radio frequency transceiver module is used for transmitting and receiving BT wireless signals or various PDUs, comprising transmitting and receiving HT-BIG related PDUs. The BT radio frequency transceiver module may also support future BLE high-rate physical layer technologies, such as 4 Mbps, 6 Mbps, and 8 Mbps. The user interface may be a button, a touch screen, a wireless control interface, etc., for acquiring instructions for operating the WBA function.

When the structure shown in FIG. 11 is the HTWBA slave device, it may also comprise a user interface, an audio input unit, an audio output unit, an audio processing unit, a baseband data and protocol processor, and a Bluetooth radio frequency transceiver module.

The baseband data and protocol processor execute the relevant protocols of the HT-BIG link, processes the BIS PDUs transmitted by the HTWBA master device received by the BT radio frequency transceiver module, and transmits them to the audio processing unit.

The audio processing unit is used for post-processing such as audio decoding, packet loss processing, equalization, and sound effects. The audio output unit is used to convert the audio signal into a sound signal. The BT radio frequency transceiver module is used for transmitting and receiving BT wireless signals or various PDUs, comprising transmitting and receiving HT-BIG related PDUs.

The BT radio frequency transceiver module may also support future BLE high-rate physical layer technologies, such as 4 Mbps, 6 Mbps, and 8 Mbps. The user interface may be a button, a touch screen, a wireless control interface, etc., for acquiring instructions for operating the WBA function. According to the embodiments of the present invention, the present invention further provides an electronic device and a readable storage medium.

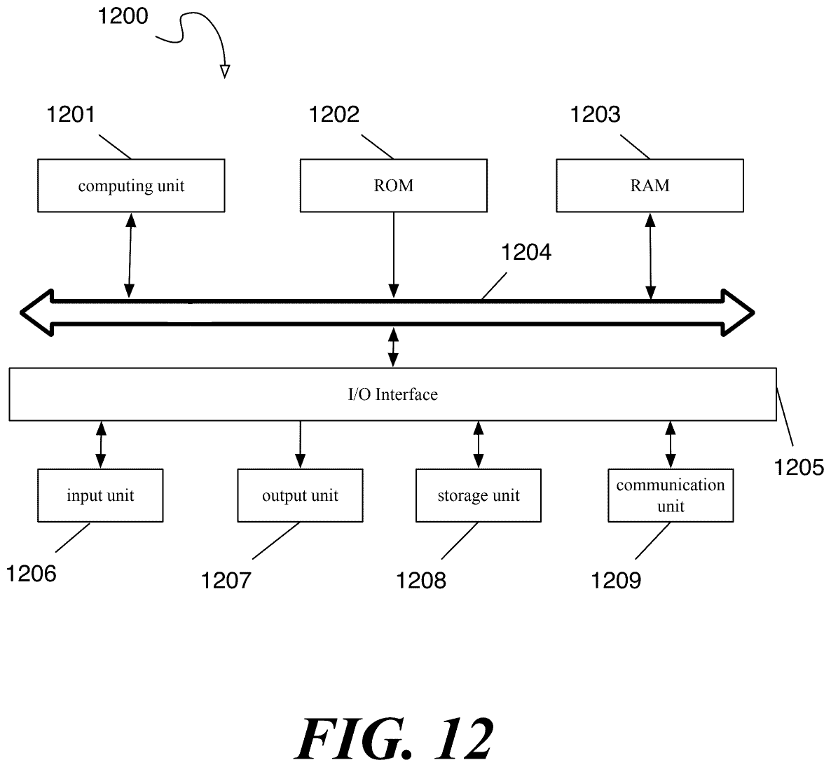

FIG. 12 shows a schematic block diagram of an example electronic device 1200 that can be used to implement the embodiments of the present invention. As shown in FIG. 12, the device 1200 comprises a computing unit 1201, which can execute various appropriate actions and processes according to a computer program stored in a Read-Only Memory (ROM) 1202 or a computer program loaded from a storage unit 1208 into a Random Access Memory (RAM) 1203. Various programs and data required for the operation of the device 1200 can also be stored in the RAM 1203. The computing unit 1201, the ROM 1202, and the RAM 1203 are connected to each other through a bus 1204. An input/output (I/O) interface 1205 is also connected to the bus 1204.

Multiple components in the device 1200 are connected to the I/O interface 1205, comprising: an input unit 1206, such as a keyboard and a mouse; an output unit 1207, such as various types of displays and speakers; a storage unit 1208, such as a magnetic disk and an optical disc; and a communication unit 1209, such as a network card, a modem, and a wireless communication transceiver. The communication unit 1209 allows the device 1200 to exchange information/data with other devices through a computer network such as the Internet and/or various telecommunication networks.

The computing unit 1201 can be various general-purpose and/or special-purpose processing components with processing and computing capabilities. Some examples of the computing unit 1201 comprise, but are not limited to, a Central Processing Unit (CPU), a Graphic Process Unit (GPU), various special purpose Artificial Intelligence (AI) computing chips, various computing units that run machine learning model algorithms, a Digital Signal Processor (DSP), and any appropriate processor, controller, microcontroller, etc. The computing unit 1201 executes the various methods and processes described above, such as the wireless audio data transmission method. For example, in some embodiments, the wireless audio data transmission method can be implemented as a computer software program, which is tangibly contained in a machine readable medium, such as the storage unit 1208. In some embodiments, part or all of the computer program can be loaded and/or installed on the device 1200 via the ROM 1202 and/or the communication unit 1209. When the computer program is loaded into the RAM 1203 and executed by the computing unit 1201, one or more steps of the wireless audio data transmission method described above can be executed. Alternatively, in other embodiments, the computing unit 1201 can be configured to execute the wireless audio data transmission method in any other appropriate way (for example, by means of firmware).

A wireless audio data transmission method applied to a source device is provided according to one embodiment of the present invention. The source device may be the master device described above. The method comprises: the source device generates a standard broadcast data packet and a compensation data packet respectively based on an audio frame in the audio stream. The standard broadcast data packet can be understood as the first broadcast data packet described above, and the compensation data packet can be understood as the second broadcast data packet described above.

The standard broadcast data packet and the compensation data packet obtained based on the same audio frame are respectively referred to as the target standard broadcast data packet and the target compensation data packet. The target standard broadcast data packet and the target compensation data packet can be understood as the target first audio data unit and the target second audio data unit described above respectively. A data amount of the target compensation data packet is smaller than that of the target standard broadcast data packet, and the target compensation data packet is used to perform packet loss compensation for the target standard broadcast data packet when the target standard broadcast data packet is lost.

The above-mentioned audio stream can be understood as the data stream corresponding to any audio, for example: the audio indicating a song, the audio indicating the soundtrack of a movie or TV drama, the audio indicating a recording (generated by recording ambient sounds, human voices, etc.), the audio indicating a voice call, etc.

There are multiple standard broadcast data packets, and multiple consecutive standard broadcast data packets form a standard broadcast data packet stream. The standard broadcast data packet stream can be understood as the primary broadcast data packet stream described above. There are also multiple compensation data packets, and multiple consecutive compensation data packets corresponding to the same audio quality form a compensation data packet stream. The compensation data packet stream can be understood as the auxiliary broadcast data packet stream described above. The audio content of the audio stream carried by the standard broadcast data packet stream and the compensation data packet stream is the same. The difference between the standard broadcast packet stream and the compensation packet stream is that the audio quality of the audio stream carried by the standard broadcast packet stream is higher relative to the compensation packet stream. Exemplarily, when the standard broadcast data packet stream corresponds to lossless audio quality, the compensation data packet stream can correspond to standard audio quality and/or high-definition audio quality.

It should be understood that there can be one or multiple paths of the standard broadcast data packet streams; when there are multiple paths of the standard broadcast data packet streams, the multiple paths of the standard broadcast data packet stream can respectively correspond to different channels (such as the left and right channels, etc.), or can respectively correspond to different languages (used for transmitting translated voices), or can respectively correspond to different setting characteristics. It should be noted that, for example, the different setting characteristics can be different somatosensory characteristics in VR/AR scenarios, such as vibration data, temperature data, visual data, sound data, etc.

There is one or more groups of compensation data packet streams corresponding to the standard broadcast data packet streams. Each group of compensation data packet stream can be one or multiple paths, and the audio qualities corresponding to multiple paths of compensation data packet streams within the same group are different from each other.

In some implementation manners, acquisition of the standard broadcast data packet and the compensation data packet can be completed based on one or more of indicators such as a sampling rate, a quantization precision, an encoding rate, a frequency response, and a dynamic range. The present invention does not limit this.

For example, the target audio frame can be encoded based on a high encoding rate to form the standard broadcast data packet corresponding to the target audio frame, and the target audio frame can be encoded based on a low encoding rate to form the compensation data packet corresponding to the target audio frame, wherein the target audio frame is any audio frame in the audio stream.

In one example, when the target standard broadcast data packet is lost, a process of performing packet loss compensation for the target standard broadcast data packet based on the target compensation data packet can be: the target compensation data packet is used as the target standard broadcast data packet, so as to ensure continuity of audio playback by sacrificing a certain audio playback quality during an audio playback process. In specific applications, the target compensation data packet and the adjacent unlost standard broadcast data packet of the target standard broadcast data packet can also be smoothed, so as to reduce loss of the finally presented audio playback effect after the compensation data packet participates in the audio playback.

In another example, when the target standard broadcast data packet is lost, the process of performing packet loss compensation for the target standard broadcast data packet based on the target compensation data packet can be: predicting or restoring the target standard broadcast data packet based on the target compensation data packet. The method further comprises: the source device transmits the standard broadcast data packet and the compensation data packet to a destination device.

In the present invention, in a transmission scenario of a high-quality audio stream, during a process of transmitting the standard broadcast data packet corresponding to the high-quality audio stream, the compensation data packet corresponding to the low-quality audio stream will also be sent, so that when the destination device cannot correctly receive the standard broadcast data packet, it can compensate for the missing standard broadcast data packet by receiving the corresponding compensation data packet, thereby reducing an overall receiving packet loss rate of the destination device, maintaining continuity of the audio stream transmission, and improving anti-interference performance of the audio stream during the transmission process.

The source device of the present invention can be understood as the audio transmitting device in the audio stream transmission process, and the destination device can be understood as the audio receiving device in the audio stream transmission process. In one embodiment, the target compensation data packet and the target standard broadcast data packet meet a preset condition, which comprises at least one of the following.

The data amount of a data portion corresponding to a first indicator in the target compensation data packet is less than that in the data portion corresponding to the first indicator in the standard broadcast data packet. The first indicator is used to represent the amplitude of the corresponding frequency spectrum of the audio signal included in the audio frame in the time domain.

The data amount of a data portion corresponding to a second indicator in the target compensation data packet is less than that in the data portion corresponding to the second indicator in the standard broadcast data packet. The second indicator is used to represent the phase of the corresponding frequency spectrum of the audio signal included in the audio frame in the time domain.

The data amount of a data portion corresponding to a third indicator in the target compensation data packet is less than that in the data portion corresponding to the third indicator in the standard broadcast data packet. The third indicator is used to represent the amplitude variation of the corresponding frequency spectrum of the audio signal included in the audio frame in the time domain.

The data amount of a data portion corresponding to a fourth indicator in the target compensation data packet is less than that in the data portion corresponding to the fourth indicator in the standard broadcast data packet. The fourth indicator is used to represent the phase variation of the corresponding frequency spectrum of the audio signal included in the audio frame in the time domain.

The data amount of a data portion corresponding to a fifth indicator in the target compensation data packet is less than that in the data portion corresponding to the fifth indicator in the standard broadcast data packet. The fifth indicator is used to represent the amplitude of the corresponding frequency spectrum of the audio signal included in the audio frame in the frequency domain.

The data amount of a data portion corresponding to a sixth indicator in the target compensation data packet is less than that in the data portion corresponding to the sixth indicator in the standard broadcast data packet. The sixth indicator is used to represent the phase of the corresponding frequency spectrum of the audio signal included in the audio frame in the frequency domain.

The data amount of a data portion corresponding to a seventh indicator in the target compensation data packet is less than that in the data portion corresponding to the seventh indicator in the standard broadcast data packet. The seventh indicator is used to represent the amplitude variation of the corresponding frequency spectrum of the audio signal included in the audio frame in the frequency domain.

The data amount of a data portion corresponding to an eighth indicator in the target compensation data packet is less than that in the data portion corresponding to the eighth indicator in the standard broadcast data packet. The eighth indicator is used to represent the phase variation of the corresponding frequency spectrum of the audio signal included in the audio frame in the frequency domain.

Both the standard broadcast data packet and the compensation data packet can be understood as data packets formed after encoding and compressing audio frames. The difference is that a data compression ratio of the compensation data packet for audio frames can be 2 to 8 times that of the standard broadcast data packet for audio frames.

In one embodiment, a packet header flag is set at a first bit of a data carrying position corresponding to the compensation data packet. In this embodiment, the first bit of the packet header flag is set, so that the receiving device (i.e., the destination device in this application) that needs to parse the compensation data packet can accurately locate position of the compensated audio data and then complete corresponding data parsing work.

The data carrying position can be understood as the position of bit resources occupied by the compensation data packet. It should be understood that within the same time period, when there are multiple compensation data packets, multiple compensation data packets correspond to one data carrying position.

In one embodiment, the transmitting the standard broadcast data packet and the compensation data packet to the destination device comprises: transmitting an extended advertising packet, an additional advertising packet, and an additional periodic advertising packet to the destination device in sequence, so that the destination device can establish a standard communication link group with the source device based on standard link information carried in the additional periodic advertising packet, wherein at least one of the extended advertising packet, the additional advertising packet, and the additional periodic advertising packet carries the compensation data packet; transmitting the standard broadcast data packet to the destination device based on the standard communication link group.

Exemplarily, one or more Broadcast Isochronous Stream (BIS) links can be created corresponding to the standard broadcast data packet stream, thereby forming a Broadcast Isochronous Group (BIG) link to transmit the aforementioned one or more paths of standard broadcast data packet streams. In this example, the broadcast isochronous group can be understood as the aforementioned standard communication link group. The standard communication link group can be understood as the first communication link group described above.

The BIS adopts an isochronous period transmitting mechanism. This period is called the ISO Interval, and typical period values are 10 ms or 20 ms. In application, the above-mentioned period values can also be adaptively adjusted based on actual needs.

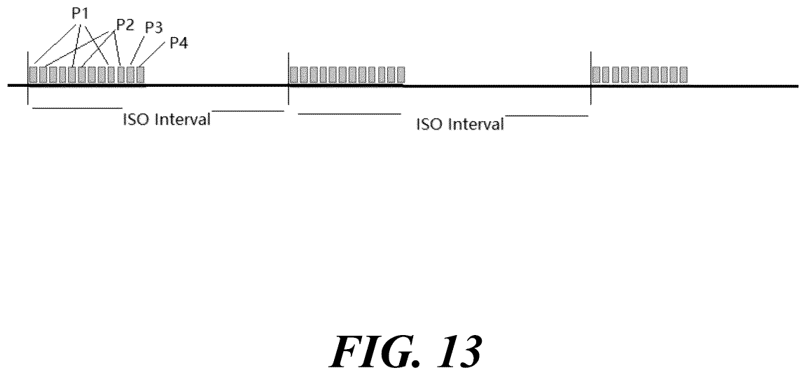

In each isochronous interval of each BIS, i data packets can be sent, and each data packet can be sent j times, wherein i and j are integers greater than or equal to 1. For example, when the BIG comprises two BISs (BIS1 and BIS2), a transmitting time slot configuration of the data packets corresponding to the two BISs can be as shown in FIG. 13. In FIGS. 13, P1 and P3 belong to the data packets of BIS1, and P2 and P4 belong to the data packets of BIS2. In the example of FIG. 13, j=3 and i=2.

To synchronize the destination device to the BIG of the source device, when the source device creates the BIG, it also creates a set of Bluetooth Low Energy (BLE) advertising sessions. This set of advertising sessions is sent periodically, and a period value of the advertising sessions can be 60 ms or 120 ms (or other values).

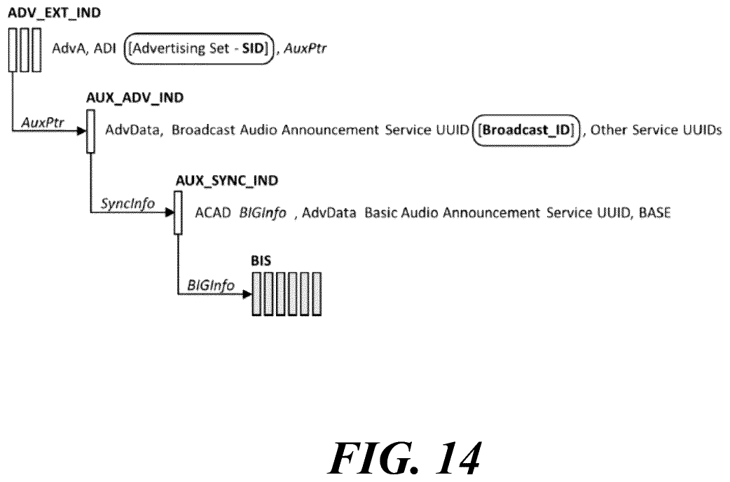

As shown in FIG. 14, this set of advertising sessions comprises an ADV_EXT_IND extended advertising, an AUX_ADV_IND additional advertising, and an AUX_SYNC_IND additional periodic advertising. The extended advertising corresponds to transmission of the extended advertising packet, the additional advertising corresponds to transmission of the additional advertising packet, and the additional periodic advertising corresponds to transmission of the additional periodic advertising packet.

In the extended advertising packet, an Advertising Set-ID in an ADI field identifies this set of BLE advertising sessions, and an AuxPrt field indicates transmitting an anchor time, a channel, and Phy data bandwidth information of the additional advertising.

The additional advertising contains a broadcast voice declaration service UUID, a broadcast ID identifier, a broadcast name, a manufacturer-defined field, and a SyncInfo field. The SyncInfo field indicates a transmitting anchor time of the additional periodic advertising, a transmitting interval of the additional periodic advertising, an access code, a CRC initial seed value, an event count, and a channel list.

The additional periodic advertising contains an ACAD BIGInfo field, a basic voice declaration service UUID field, a presentation delay field, a CODEC encoding/decoding configuration field, a BIS parameter field, and a manufacturer-defined field. The BIGInfo field contains information such as a time anchor for the start of BIG data packet transmission, the ISO isochronous interval, the number of BISs, the number of sub-events, the number of retransmissions, an access code seed, the maximum SDU length, the SDU interval, the maximum PDU length, the channel list, the CRC initial value, and the BIS packet count.

When the destination device is in an advertising scanning mode, it will periodically open a scanning window and continuously receive the extended advertising packet. After receiving the extended advertising packet, it parses the data content of the extended advertising packet. According to instructions of the data content, it receives the additional advertising packet at the corresponding channel and the corresponding time anchor. After receiving the additional advertising packet, according to the instruction of the data content therein, it obtains the BIG type information, identifier, and the index of the additional periodic advertising, and continues to receive the additional periodic advertising at the corresponding channel and the corresponding time anchor and synchronizes with the additional periodic advertising, and then continuously receives this additional periodic advertising.

According to data content of the additional periodic advertising, the destination device can decide to achieve the synchronization of the BIG and the synchronization with one or more BISs within the BIG, and internally establish a BIS data receiving channel and a channel for routing the BIS data to a CODEC decoding and playback layer, so that the destination device can play the voice transmitted from the source device based on the BIG.

In this embodiment, at least one of the extended advertising packet, the additional advertising packet, and the additional periodic advertising packet carries the compensation data packet. On the premise of not affecting the device compatibility and the BIG synchronization of the destination device, the idle time between the BLE advertising time slot and the BIG time slot is more compactly utilized, the number of transmissions of the compensation data packet is increased, and thus the packet loss probability of the compensation data packet is reduced.

Exemplarily, the manufacturer-defined field can be added to the extended advertising packet, the additional advertising packet, and/or the additional periodic advertising packet. That is, some or all bits of a reserved field in the extended advertising packet, the additional advertising packet, and/or the additional periodic advertising packet are used to encapsulate the compensation data packet in the added manufacturer-defined field, and then at least one of the extended advertising packet, the additional advertising packet, and the additional periodic advertising packet carries the compensation data packet.

In this embodiment, after the destination device achieves the synchronization of the BIG, it can periodically receive the extended advertising and the additional advertising.

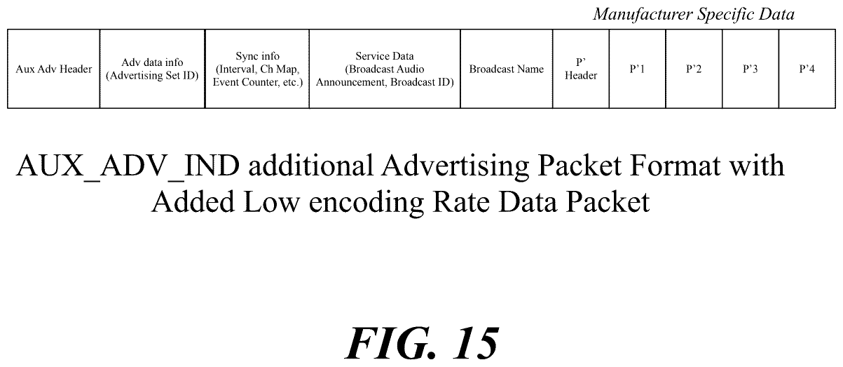

Exemplarily, if it is set that there are normal encoding rate data packets P1-P4, the additional advertising packet carrying the compensation data packet can be as shown in FIG. 15. In FIG. 15, the low encoding rate data packet is the compensation data packet, P′ in FIG. 4 is the packet header flag, and P′1, P′2, P′3, and P′4 are all low encoding rate data packets; and P′1, P′2, P′3, and P′4 respectively correspond to the low encoding rate data packet packets of the normal encoding rate data packets P1-P4, wherein the normal encoding rate data packet can be understood as the aforementioned standard broadcast data packet.

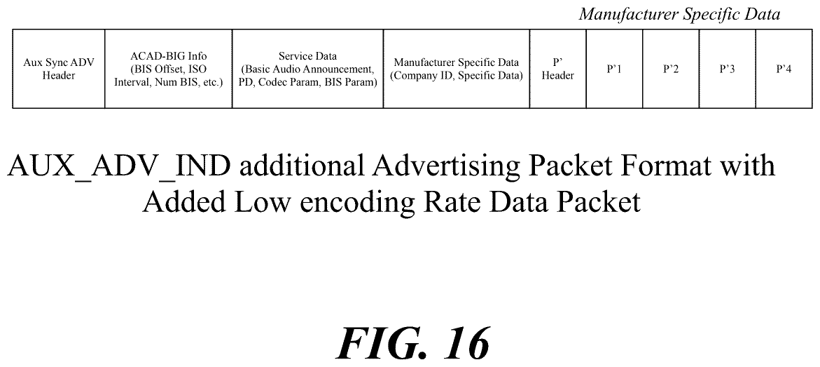

Similarly, if it is set that there are normal encoding rate data packets P1-P4, the additional periodic advertising packet carrying the compensation data packet can be as shown in FIG. 16.

In one embodiment, the transmitting the standard broadcast data packet and the compensation data packet to the destination device comprises: transmitting an extended advertising packet, an additional advertising packet, and an additional periodic advertising packet to the destination device in sequence, so that the destination device can establish a standard communication link group with the source device based on the standard link information carried in the additional periodic advertising packet, and the destination device can establish a communication compensation link group with the source device based on the compensation link information carried in the additional advertising packet; transmitting the standard broadcast data packet to the destination device within consecutive isochronous intervals based on the standard communication link group, and transmitting the compensation data packet to the destination device based on the communication compensation link group. The communication compensation link group can be understood as the second communication link group described above.

In this embodiment, in addition to the standard communication link group, the communication compensation link group is additionally established to transmit the compensation data packet. The standard link information used to establish the standard communication link group is carried in the additional periodic advertising packet, and the compensation link information used to establish the compensation link group is carried in the additional advertising packet. The compensation link group is a link group corresponding to the isochronous mechanism.

Wherein, the compensation link information comprises a link event count value, an access code, a CRC check seed, a channel calculation algorithm, etc. for creating the corresponding communication compensation link group.

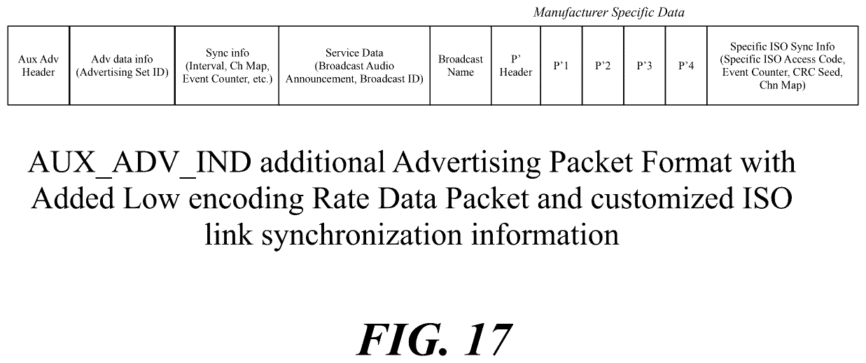

Exemplarily, the additional advertising packet carrying the compensation link information and the compensation data packet can be as shown in FIG. 17, and a Specific ISO Sync info field in FIG. 16 is the compensation link information.

It should be noted that in the application, for the same multiple compensation data packets, a part of the multiple compensation data packets can be carried in at least one of the extended advertising packet, the additional advertising packet, and the additional periodic advertising packet, and the other part is transmitted through the corresponding communication compensation link group, so as to increase transmission opportunities of the compensation data packet and further enhance the anti-interference ability of the audio stream during the transmission process.

In one embodiment, there are M groups of the communication compensation link groups, multiple consecutive compensation data packets form a compensation data packet stream, there are M paths of the compensation data packet streams, and the M paths of the compensation data packet streams respectively correspond one-to-one to the M groups of communication compensation link groups, wherein M is a positive integer.

In one embodiment, within any one of the isochronous intervals, a time-domain position occupied by any one of the compensation data packets is located after a time-domain position occupied by the standard broadcast data packet, and the time-domain position occupied by any one of the compensation data packets is located before a time-domain position occupied by the target advertising packet, wherein the target advertising packet is the extended advertising packet, the additional advertising packet, or the additional periodic advertising packet; or within any one of the isochronous intervals, the time-domain position occupied by any one of the compensation data packets is located after the time-domain position occupied by the target advertising packet. In this embodiment, multiple allocation methods for the time-domain position of the compensation data packet are provided, which makes the application of the method described in the present invention more flexible.

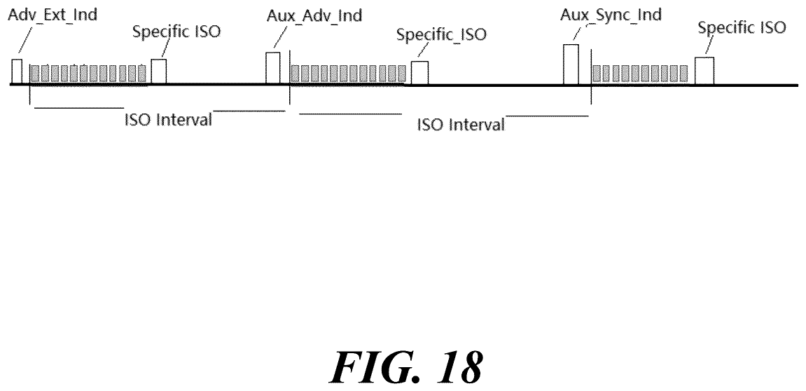

A data transmitting time slot for the compensation data packet can be added between a BLE broadcast session time slot and a BIG time slot, wherein the BLE broadcast session time slot is used to indicate the time-domain position occupied by the target advertising packet, and the BIG time slot is used to indicate the time-domain position occupied by the standard broadcast data packet. A data transmitting time slot for the compensation data packet can also be added after the BIG time slot, as shown in FIG. 18, wherein gray squares in FIG. 18 are used to represent the BIG time slots.

In one embodiment, when the transmitting period of the target standard

broadcast data packet is the first period, the transmitting period of the target compensation data packet is the second period, and the first period and the second period are different periods, the compensation link information carries an interleaving mode field, and the interleaving mode field is used to indicate a difference in the transmitting period between the target compensation data packet and the target standard broadcast data packet.

By setting the interleaving mode field, the total duration spanned by multiple data packets generated based on the same audio frame is extended, and thus the probability of the packet loss problem caused by the channel occupation is reduced, and the anti-interference ability of the audio stream during the transmission process is further enhanced.

The total duration spanned by multiple data packets generated from the same audio frame is the difference between the time corresponding to the first transmitted data packet and the time corresponding to the last transmitted data packet in the multiple data packets generated by the same audio frame.

For example, taking the transmitting period of the target standard broadcast data packet as a reference period, the transmitting period of the target compensation data packet will be advanced or delayed by one or more periods relative to the reference period. In this way, even if there is channel occupation within a certain period, since there are still opportunities for data packet transmission in other periods, the situation where both the standard broadcast data packet and the compensation data packet corresponding to a certain audio frame are lost will not occur, thus greatly increasing the reliability of the audio stream transmission. In the application, in addition to indicating the difference in the transmitting period between the target compensation data packet and the target standard broadcast data packet, the interleaving mode field can also indicate the number of target compensation data packets.

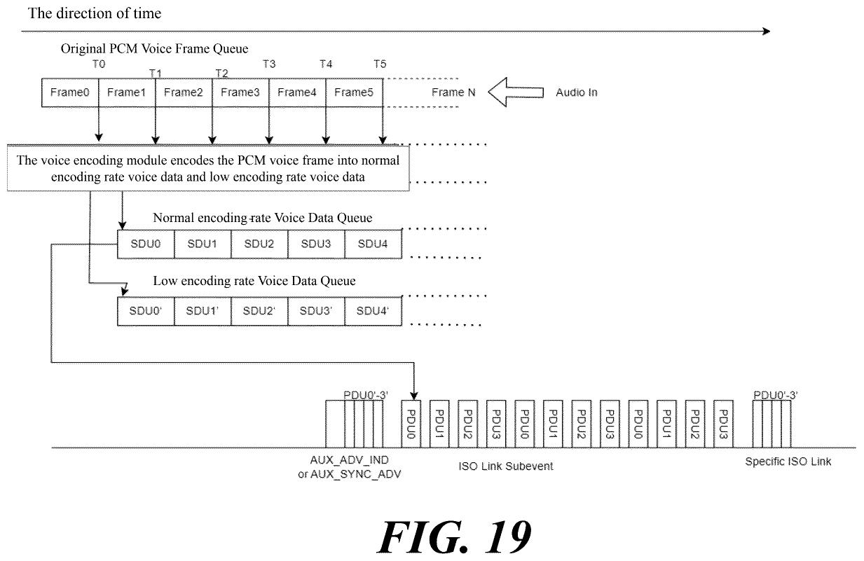

As shown in FIG. 19, the process of encoding and transmitting the audio frame in the source device can be as follows in one example:

A voice encoding module of the source device retrieves data from an original Pulse Code Modulation (PCM) frame queue, performs encoding, and simultaneously encodes one path of normal encoding rate voice data stream (corresponding to the aforementioned standard broadcast data packet stream) and one path of low encoding rate voice data stream (corresponding to the aforementioned compensation data packet stream), and puts them into the normal encoding rate voice data queue and the low encoding rate voice data queue respectively; at a pre-configured moment, a Bluetooth communication module of the source device retrieves data from the low encoding rate voice data queue and encapsulates it into the manufacturer-defined field of the additional advertising packet or the additional periodic advertising packet (i.e., the time slot part corresponding to AUX ADV_IND or AUX_SYNC_ADV in FIG. 19), and encapsulates parameters such as the packet sequence number; at the pre-configured moment, the Bluetooth communication module of the source device retrieves data from the normal encoding rate voice data queue and encapsulates it into the transmitting time slot of the marked isochronous link (i.e., the time slot part corresponding to ISO Link Subevent in FIG. 19), and encapsulates parameters such as the packet sequence number; at the pre-configured moment, a Bluetooth communication module of the source device retrieves data from the low encoding rate voice data queue and encapsulates it into the transmitting time slot of the customized isochronous link (i.e., the time slot part corresponding to Specific ISO Link in FIG. 19), and encapsulates parameters such as the packet sequence number.

Based on the application of the above method, in places such as airports, railway stations, restaurants, cinemas, parks, etc. that require public audio broadcasting, users can use dedicated receiving devices/wireless headphones, wireless speakers, and other devices that support the standard wireless speaker broadcasting system to receive and play announcements, music, etc., to obtain high-quality sound effects, and at the same time eliminate the environmental noise caused by the external broadcasting.

A wireless audio data transmission method applied to a destination device is provided according to one embodiment of the present invention. The wireless audio data transmission method comprises: receiving the standard broadcast data packet sent by the source device, and receiving the compensation data packet sent by the source device; when the target standard broadcast data packet is successfully received, performing parsing based on the target standard broadcast data packet to obtain the first target audio data; when the target standard broadcast data packet fails to be received and the target compensation data packet is successfully received, performing packet loss compensation based on the target compensation data packet to obtain the second target audio data.

In one embodiment, the receiving the standard broadcast data packet sent by the source device and receiving the compensation data packet sent by the source device comprises: receiving the extended advertising packet, the additional advertising packet, and the additional periodic advertising packet sent by the source device in sequence; establishing a standard communication link group with the source device according to the standard link information carried in the additional periodic advertising packet, and establish a communication compensation link group with the source device according to the compensation link information carried in the additional advertising packet; receiving the standard broadcast data packet sent by the source device within consecutive isochronous intervals based on the standard communication link group, and receive the compensation data packet sent by the source device based on the communication compensation link group.

In one embodiment, the receiving the compensation data packet sent by the source device further comprises: receiving the extended advertising packet sent by the source device, and parsing the extended advertising packet to obtain the compensation data packet; and/or, receiving the additional advertising packet sent by the source device, and parsing the additional advertising packet to obtain the compensation data packet; and/or, receiving the additional periodic advertising packet sent by the source device, and parsing the additional periodic advertising packet to obtain the compensation data packet.

In this embodiment, the destination device can obtain the compensation data packet by receiving at least one of the extended advertising packet, the additional advertising packet, and the additional periodic advertising packet sent by the source device, so as to increase the number of transmissions of the compensation data packet without adding additional communication links.

In one embodiment, the receiving the additional advertising packet sent by the source device comprises: determining a first channel index of the additional advertising packet indicated by the previously received extended advertising packet according to the previously received extended advertising packet; determining a second channel index according to the count information and the first channel index, wherein the count information is used to indicate the number of events corresponding to the communication compensation link group or the number of periodic advertising events corresponding to the additional periodic advertising packet; and receiving the additional advertising packet sent by the source device according to the second channel index.

In this embodiment, when the additional advertising packet carries the compensation data packet, by counting the number of events corresponding to the communication compensation link group or the number of periodic advertising events corresponding to the additional periodic advertising packet, and performing corresponding calculations in combination with the previous channel index, the time point and frequency point for receiving the additional advertising packet next time are determined, thereby realizing the periodic reception of the additional advertising packet by the destination device, and skipping the repeated reception action of the extended advertising packet by the destination device at the same time. Both the first channel index and the second channel index carry information indicating the time point and frequency point for receiving the additional advertising packet.

In one example, the process of the destination device receiving the compensation data packet is as follows: the destination device receives the additional advertising packet Aux_Adv_IND and parses the additional advertising packet to obtain each field; the additional advertising packet containing an index information field Specific ISO Sync Info of the customized isochronous link (which can be understood as the aforementioned communication compensation link group), and obtains the time offset, access code, event count value, CRC seed initial value, channel mapping table, and channel calculation algorithm of the customized isochronous link from it; uses the time offset to calculate a starting time point of receiving the data packet of the customized isochronous link Specific ISO for the first time (which can be understood as the time point included in the aforementioned first channel index); uses the event count value, channel mapping table, and the channel calculation algorithm to calculate the channel for receiving the customized isochronous link Specific ISO for the first time (which can be understood as the frequency point included in the aforementioned first channel index); configures the CRC seed initial value in advance based on the starting time point of the data packet, which is used to calculate whether the received data packet of Specific ISO can pass the CRC check; configures the receiving channel at this time point; configures the access code at this time point; a Bluetooth Modem and RF receiver starts to receive the air interface data at the preset time on the above-configured channel, and continues to receive the data until the reception is completed after receiving the preamble data that meets the access code judgment threshold; performs the CRC check on the received data; reports the data packet after passing the CRC check. The data packet is a low encoding rate data packet (i.e., the aforementioned compensation data packet).

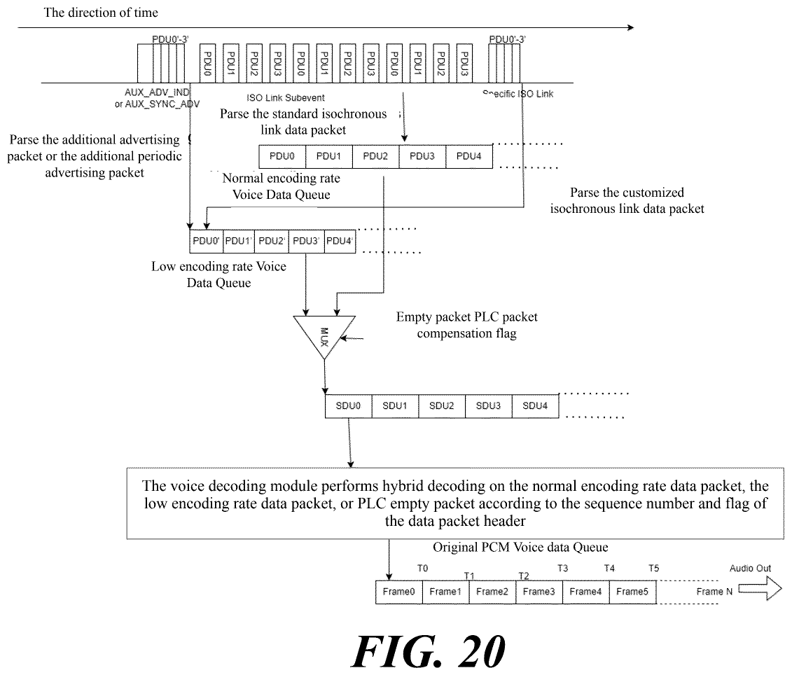

In one example, as shown in FIG. 20, the process of the destination device receiving the normal encoding rate data packet and the low encoding rate data packet, combining them to form a mixed-rate voice stream and performing mixed-rate decoding can be as follows.

A Bluetooth communication module of the destination device receives the additional advertising packet or the additional periodic advertising packet, parses the manufacturer-defined field therein, and parses and obtains the low encoding rate data packet identification field from the manufacturer-defined field.

The destination device judges that the subsequent data is the content of the low encoding rate data packet based on the low encoding rate data packet identification field, receive and parse the data, and put the data packet into the low encoding rate voice data queue. If the data packet at the corresponding sequence number position is not received, the destination device submits an all-0 data packet with an empty packet flag to the low encoding rate voice data queue.

The Bluetooth communication module of the destination device receives the BIG data packet on the standard isochronous link, and puts the data packet into the normal encoding rate voice data queue. If the data packet at the corresponding sequence number position is not received, the destination device submits an all-0 data packet with an empty packet flag to the normal encoding rate voice data queue.

The Bluetooth communication module of the destination device receives the data packet on the customized standard isochronous link, and puts the data packet into the low encoding rate voice data queue. If the data packet at the corresponding sequence number position is not received, the destination device submits an all-0 data packet with an empty packet flag to the low encoding rate voice data queue.

According to the time sequence relationship between the time slot of the additional advertising packet or the additional periodic advertising packet and the time slot of the customized isochronous link, if the data packet with the corresponding sequence number submitted later is one non-empty packet and the data packet with the corresponding sequence number submitted earlier is one empty packet, the former is replaced with the latter.

According to the time sequence relation between the time slot of the additional advertising packet or the time slot of the additional periodic advertising packet and the time slot of the customized isochronous synchronous link, the latter is compared with the time of the time slot of the standard isochronous link, and after the latter is submitted, the normal encoding rate data queue and the low encoding rate data queue are merged.

The merging is based on the normal encoding rate voice data queue. If the data packet with a certain sequence number is one empty packet and the data packet with the corresponding sequence number in the low encoding rate voice data queue is a non-empty packet, the destination device replaces the corresponding empty packet in the normal encoding rate voice data queue with the low encoding rate data packet with this sequence number, and set this packet as a low encoding rate data flag. If the data packet with a certain sequence number is one empty packet and the data packet with the corresponding sequence number in the low encoding rate voice data queue is also one empty packet, the destination device sets the data packet with this sequence number as one empty packet data flag; the merged queue is used as a user data unit queue.

At the pre-configured time point, a voice decoding module obtains the voice data packet from the user data unit queue and performs decoding processing. Before decoding, the voice decoding module first read the header flag of the data packet, perform hybrid decoding on the normal encoding rate data, the low encoding rate data, and the PLC empty packet. After decoding, the voice decoding module forms a PCM voice data queue, perform the next step of voice processing and send it to a voice peripheral for playback.

Program code for implementing the methods of the present invention may be written in any combination of one or more programming languages. Such program code may be provided to a processor or controller of a general-purpose computer, a specialized computer, or other programmable data processing device such that the program code when executed by the processor or controller causes the functions/operations set forth in the flowchart and/or the block diagram to be implemented. The program code may be executed entirely on the machine, partially on the machine, partially on the machine as a stand-alone software package and partially on a remote machine or entirely on a remote machine or server.

In one embodiment, the present invention also provides a computer-readable storage medium having a computer program stored thereon. When the computer program is executed by a processor to realize the BLE broadcast communication method in the above-described embodiments and can achieve the same technical effect, which will not be repeated herein in order to avoid repetition. The computer-readable storage medium can be a read-only memory (ROM), random access memory (RAM), magnetic disc or optical disc, etc.

The embodiments of this application are described above in conjunction with the accompanying drawings, but this application is not limited to the specific embodiments described above, the specific embodiments described above are merely illustrative and not limiting, and the person of ordinary skill in the field of this application, without departing from the purpose of the application and the scope of protection of the claims, may also make many forms, all of which are under the protection of this application.

Although preferred embodiments of the present invention have been described, additional changes and modifications to these embodiments may be made once the basic creative concepts are known to those skilled in the art. The appended claims are therefore intended to be interpreted to comprise preferred embodiments and all changes and modifications falling within the scope of this application.

Obviously, a person skilled in the art may make various changes and variations to the application without departing from the spirit and scope of the application. Thus, if these modifications and variations of this application fall within the scope of the claims and their equivalent technologies, the application is also intended to comprise these changes and variations.

What is claimed is:

1. A wireless audio data transmission method, applied to a master device configured to perform broadcast communication with one or more first slave devices within continuous isochronous intervals to transmit an audio stream, the method comprising:
obtaining a first audio data unit and a second audio data unit from an audio frame in the audio stream, wherein the first audio data unit and the second audio data unit obtained from the same audio frame are defined as a target first audio data unit and a target second audio data unit, respectively, and wherein the audio information carried by the target second audio data unit is less audio information that carried by the target first audio data unit;
encapsulating the first audio data unit into a first broadcast data packet and encapsulating the second audio data unit into a second broadcast data packet; and
transmitting the first broadcast data packet via a first communication link group and the second broadcast data packet via a second communication link group within the same isochronous interval.

2. The method according to claim 1, wherein:
an airtime slot occupied by the first audio data unit is greater than that occupied by the second audio data unit;
there are at least M groups of the second audio data units, and there are M groups of the second communication link groups, and a plurality of consecutive second broadcast data packets form an auxiliary broadcast data packet stream, and there are M paths of the auxiliary broadcast data packet streams, wherein M is a positive integer;
the M paths of the auxiliary broadcast data packet streams respectively correspond one-to-one to the M groups of the second communication link groups;
one or more of the second audio data units are encapsulated within one second broadcast data packet;
the airtime slots occupied by the second audio data units of the second broadcast data packets transmitted on different second communication link groups are different; and
the airtime slot occupied by any one of the first audio data units is greater than that occupied by any one of the second audio data units.

3. The method according to claim 2, wherein:
within the same unit transmission duration, the second audio data unit is transmitted more frequently than the first audio data unit;
within the same unit transmission duration, the shorter the airtime slot occupied by the second audio data unit, the greater the number of its transmissions; and
the unit transmission duration corresponds to the time required for the first communication link group to retransmit the first broadcast data packet once.

4. The method according to claim 1, wherein the obtaining a first audio data unit and a second audio data unit from an audio frame in the audio stream comprises:
using a high encoding rate to encode a target audio frame to obtain a corresponding target first audio data unit, and using a low encoding rate to encode the target audio frame to obtain a corresponding target second audio data unit, wherein the target audio frame is any one of the current audio frame within the audio stream;
the encoding rates of multiple second audio data units within one second broadcast data packet are the same; and
the encoding rates of the second audio data units of the second broadcast data packets transmitted over different second communication link groups are different.

5. The method according to claim 1, wherein:
the airtime slot occupied by the first audio data unit is greater than that occupied by the second audio data unit;
within a single isochronous interval, the airtime slot occupied by the first audio data unit is adjacent to the airtime slot occupied by the second audio data unit;
the airtime slot occupied by the first audio data unit is at least twice that of the second audio data unit; and
the audio information carried by the target second audio data unit is a proper subset of the audio information carried by the target first audio data unit.

6. The method according to claim 1, wherein the second audio data unit is used as candidate audio data to compensate for the audio information carried by the first broadcast data packet when the first slave device fails to receive the first broadcast data packet.

7. The method according to claim 6, wherein the audio information comprises one of: an amplitude, a phase, an amplitude variation, a phase variation of a corresponding frequency spectrum of the audio data unit in the time domain; and an amplitude, a phase, an amplitude variation, a phase variation of a corresponding frequency spectrum of the audio data unit in the frequency domain.

8. The method according to claim 7, wherein the audio information carried by the target second audio data unit being less than audio information carried by the target first audio data unit comprises at least one of the following:
a data amount of a data portion corresponding to a first indicator in the target second audio data unit is less than a data amount of a data portion corresponding to the first indicator in the target first audio data unit, and the first indicator is used for representing the amplitude of the corresponding frequency spectrum of the audio data unit in the time domain;
a data amount of a data portion corresponding to a second indicator in the target second audio data unit is less than a data amount of a data portion corresponding to the second indicator in the target first audio data unit, and the second indicator is used for representing the phase of the corresponding frequency spectrum of the audio data unit in the time domain;
a data amount of a data portion corresponding to a third indicator in the target second audio data unit is less than a data amount of a data portion corresponding to the third indicator in the target first audio data unit, and the third indicator is used for representing the amplitude variation of the corresponding frequency spectrum of the audio data unit in the time domain;
a data amount of a data portion corresponding to a fourth indicator in the target second audio data unit is less than a data amount of a data portion corresponding to the fourth indicator in the target first audio data unit, and the fourth indicator is used for representing the phase variation of the corresponding frequency spectrum of the audio data unit in the time domain;
a data amount of a data portion corresponding to a fifth indicator in the target second audio data unit is less than a data amount of a data portion corresponding to the fifth indicator in the target first audio data unit, and the fifth indicator is used for representing the amplitude of the corresponding frequency spectrum of the audio data unit in the frequency domain;
a data amount of a data portion corresponding to a sixth indicator in the target second audio data unit is less than a data amount of a data portion corresponding to the sixth indicator in the target first audio data unit, and the sixth indicator is used for representing the phase of the corresponding frequency spectrum of the audio data unit in the frequency domain;
a data amount of a data portion corresponding to a seventh indicator in the target second audio data unit is less than a data amount of a data portion corresponding to the seventh indicator in the target first audio data unit, and the seventh indicator is used for representing the amplitude variation of the corresponding frequency spectrum of the audio data unit in the frequency domain;
a data amount of the data portion corresponding to an eighth indicator in the target second audio data unit is less than data amount of the data portion corresponding to the eighth indicator in the target first audio data unit, and the eighth indicator is used for representing the phase variation of the corresponding frequency spectrum of the audio data unit in the frequency domain.

9. The method according to claim 2, wherein multiple consecutive first broadcast data packets form a primary broadcast data packet stream, and the master device transmits an auxiliary synchronization control data packet via a periodic advertising channel, the auxiliary synchronization control data packet comprising:
primary link information of the first communication link group; and
M auxiliary link information corresponding to the M groups of second communication link groups; and wherein the auxiliary synchronization control data packet enables the first slave device to: synchronize with the master device; receive the primary broadcast data packet stream based on the first communication link group; and receive the M paths of auxiliary broadcast data packet streams based on the M groups of second communication link groups.

10. The method according to claim 9, wherein the auxiliary synchronization control data packet further comprises:
M enable parameters corresponding one-to-one to the M groups of second communication link groups, each parameter indicating whether its corresponding second communication link group is enabled.

11. The method according to claim 10, wherein:
the first communication link group is a Broadcast Isochronous Group (BIG) link;
the second communication link group is at least one of, a BIG link or a non-BIG link, for transmitting audio data; and
the auxiliary synchronization control data packet is formatted as a common extended advertising payload, wherein: its extended header carries Broadcast Isochronous Group (BIG) information, and the M enable parameters occupy part or all of a reserved field within the BIG information.

12. A wireless audio data transmission method,
applied to a first slave device configured to perform broadcast communication with a master device within continuous isochronous intervals to receive an audio stream, the method comprising:
receiving a first broadcast data packet transmitted by the master device via a first communication link group and a second broadcast data packet transmitted by the master device via a second communication link group within the same isochronous interval;
wherein the first broadcast data packet is obtained by encapsulating the first audio data unit and the second broadcast data packet is obtained by encapsulating the second audio data unit; and
wherein the first audio data unit and second audio data unit, obtained from the same audio frame, are defined as a target first audio data unit and a target second audio data unit, respectively, and the target second audio data unit carries less audio information than the target first audio data unit.

13. The method according to claim 12, wherein:
the airtime slot occupied by the first audio data unit is greater than that occupied by the second audio data unit;
the audio information carried by the target second audio data unit is a proper subset of the audio information carried by the target first audio data unit;
at least M groups of second audio data units and M groups of second communication link groups are present;
multiple consecutive second broadcast data packets form an auxiliary broadcast data packet stream, and there are M paths of auxiliary broadcast data packet streams, where M is a positive integer;
the M paths of the auxiliary broadcast data packet streams correspond one-to-one to the M groups of second communication link groups;
one or more second audio data units are encapsulated within a single second broadcast data packet;
the airtime slots occupied by second audio data units in different second broadcast data packets, transmitted over different second communication link groups, vary; and
the airtime slot occupied by any first audio data unit is greater than that occupied by any second audio data unit.

14. The method according to claim 13, further comprising:
before receiving the first broadcast data packet via the first communication link group and the second broadcast data packet via the second communication link group, receiving an auxiliary synchronization control data packet transmitted by the master device via a periodic advertising channel, wherein the auxiliary synchronization control data comprises:
primary link information of the first communication link group; and
M auxiliary link information corresponding to the M groups of second communication link groups; and
synchronizing with the master device based on the auxiliary synchronization control data packet.

15. The method according to claim 14, wherein the auxiliary synchronization control data packet comprises M enable parameters corresponding one-to-one to the M groups of second communication link groups, each parameter indicating whether its corresponding second communication link group is enabled; and
receiving the second broadcast data packet via the second communication link group comprises:
receiving the second broadcast data packet transmitted by the master device via an enabled second communication link group when the first communication link group is in an abnormal state, wherein the abnormal state is defined as:
the communication quality of the first communication link group falling below a quality threshold; and/or
the variation amplitude of the communication quality of the first communication link group exceeding an amplitude threshold.

16. The method according to claim 12, wherein the second audio data unit is used as candidate audio data to compensate for the audio information carried by the first broadcast data packet when the first slave device fails to receive the first broadcast data packet.

17. The method according to claim 16, wherein the audio information comprises at least one of the following: an amplitude, a phase, an amplitude variation, a phase variation of a corresponding frequency spectrum of the audio data unit in a time domain, and an amplitude, a phase, an amplitude variation, a phase variation of a corresponding frequency spectrum of the audio data unit in a frequency domain.

18. The method according to claim 17, wherein the audio information carried by the target second audio data unit being less than audio information carried by the target first audio data unit comprises at least one of the following:
a data amount of a data portion corresponding to a first indicator in the target second audio data unit is less than a data amount of a data portion corresponding to the first indicator in the target first audio data unit, and the first indicator is used for representing the amplitude of the corresponding frequency spectrum of the audio data unit in the time domain;
a data amount of a data portion corresponding to a second indicator in the target second audio data unit is less than a data amount of a data portion corresponding to the second indicator in the target first audio data unit, and the second indicator is used for representing the phase of the corresponding frequency spectrum of the audio data unit in the time domain;
a data amount of a data portion corresponding to a third indicator in the target second audio data unit is less than a data amount of a data portion corresponding to the third indicator in the target first audio data unit, and the third indicator is used for representing the amplitude variation of the corresponding frequency spectrum of the audio data unit in the time domain;
a data amount of a data portion corresponding to a fourth indicator in the target second audio data unit is less than a data amount of a data portion corresponding to the fourth indicator in the target first audio data unit, and the fourth indicator is used for representing the phase variation of the corresponding frequency spectrum of the audio data unit in the time domain;
a data amount of a data portion corresponding to a fifth indicator in the target second audio data unit is less than a data amount of a data portion corresponding to the fifth indicator in the target first audio data unit, and the fifth indicator is used for representing the amplitude of the corresponding frequency spectrum of the audio data unit in the frequency domain;
a data amount of a data portion corresponding to a sixth indicator in the target second audio data unit is less than a data amount of a data portion corresponding to the sixth indicator in the target first audio data unit, and the sixth indicator is used for representing the phase of the corresponding frequency spectrum of the audio data unit in the frequency domain;
a data amount of a data portion corresponding to a seventh indicator in the target second audio data unit is less than a data amount of a data portion corresponding to the seventh indicator in the target first audio data unit, and the seventh indicator is used for representing the amplitude variation of the corresponding frequency spectrum of the audio data unit in the frequency domain;
a data amount of the data portion corresponding to an eighth indicator in the target second audio data unit is less than data amount of the data portion corresponding to the eighth indicator in the target first audio data unit, and the eighth indicator is used for representing the phase variation of the corresponding frequency spectrum of the audio data unit in the frequency domain.

19. The method according to claim 12, further comprising:
when at least two candidate audio data units corresponding to the same audio frame are successfully received, selecting the candidate audio data unit carrying the most audio information as the target candidate audio data unit, wherein the target candidate audio data unit is the first audio data unit or the second audio data unit.

20. A wireless audio data transmission device, applied to a master device configured to perform broadcast communication with one or more first slave devices within continuous isochronous intervals to transmit an audio stream, the device comprising:
an obtaining module, configured to obtain a first audio data unit and a second audio data unit from an audio frame in the audio stream, wherein:
the first audio data unit and the second audio data unit obtained from the same audio frame are defined as a target first audio data unit and a target second audio data unit, respectively; and
the audio information carried by the target second audio data unit is less than that carried by the target first audio data unit;
an encapsulating module, configured to encapsulate the first audio data unit into a first broadcast data packet and encapsulate the second audio data unit into a second broadcast data packet; and
a broadcast module, configured to transmit:
the first broadcast data packet via a first communication link group; and
the second broadcast data packet via a second communication link group, within the same isochronous interval.

21. The device according to claim 20, wherein the obtaining module is further configured to:
encode a target audio frame at a high encoding rate to obtain the corresponding target first audio data unit, and encode the same target audio frame at a low encoding rate to obtain the corresponding target second audio data unit, wherein the target audio frame is any audio frame within the audio stream;
ensure that all second audio data units within a single second broadcast data packet have the same encoding rate;
allow second audio data units in different second broadcast data packets, transmitted over different second communication link groups, to have different encoding rates; and
use the second audio data unit as candidate audio data to compensate for the audio information carried by the first broadcast data packet when the first slave device fails to receive the first broadcast data packet.

22. The device according to claim 20, wherein:
the airtime slot occupied by the first audio data unit is greater than that occupied by the second audio data unit;
the audio information carried by the target second audio data unit is a proper subset of the audio information carried by the target first audio data unit;
at least M groups of second audio data units and M groups of second communication link groups are present;
multiple consecutive second broadcast data packets form an auxiliary broadcast data packet stream, and there are M paths of auxiliary broadcast data packet streams, where M is a positive integer;
the M paths of the auxiliary broadcast data packet streams correspond one-to-one to the M groups of second communication link groups;
one or more second audio data units are encapsulated within a single second broadcast data packet;
the airtime slots occupied by second audio data units in different second broadcast data packets, transmitted over different second communication link groups, vary; and
the airtime slot occupied by any first audio data unit is greater than that occupied by any second audio data unit.

23. The device according to claim 22, wherein:
multiple consecutive first broadcast data packets form a primary broadcast data packet stream;
the master device transmits an auxiliary synchronization control data packet via a periodic advertising channel, wherein the auxiliary synchronization control data comprises:
primary link information of the first communication link group; and
M auxiliary link information corresponding to the M groups of second communication link groups;
the auxiliary synchronization control data packet is used for the first slave device to:
synchronize with the master device;
receive the primary broadcast data packet stream via the first communication link group; and
receive the M paths of auxiliary broadcast data packet streams via the M groups of second communication link groups;
the auxiliary synchronization control data packet comprises M enable parameters corresponding one-to-one to the M groups of second communication link groups, each parameter indicating whether its corresponding second communication link group is enabled; and
the auxiliary synchronization control data packet is formatted as a common extended advertising payload, wherein:
its extended header carries Broadcast Isochronous Group (BIG) information; and
the M enable parameters occupy part or all of a reserved field within the BIG information.
